(19) United States
(12) Patent Application Publication
(10) Pub. No.: US 2009/0006842 A1
(43) Pub. Date: Jan. 1, 2009

(54) Sealing Electronic Data Associated With Multiple Electronic Documents

(76) Inventors: John Gordon Ross, Chelmsford (GB); Michael Wymark Clarke, Halstead (GB); David Cornwell, Colchester (GB)

Correspondence Address: PROSKAUER ROSE LLP, ONE INTERNATIONAL PLACE, BOSTON, MA, 02110, US

(21) Appl. No.: 11/768,776

(22) Filed: Jun. 26, 2007

(51) Int. Cl. H04L 9/32

(52) U.S. Cl. 713/155

(57) ABSTRACT

The description generally provides for systems and methods for a mobile communication network. Archives of seals can be sealed to protect the integrity of the seals and facilitate validation in the event a sealing party's sealed registration document is revoked. A document can be sealed multiple times to nest seals within other seals. Specific evidentiary metadata can be included by the sealing party. A main document including or associated with other documents can be sealed as a collection of documents. The seal of the main document can include external references to the files included in the main document to verify the external files were not changed or altered.

### TECHNICAL FIELD

This description relates generally to computer-based methods and apparatuses, including computer program products, associated with sealing electronic data.

### BACKGROUND

Online transactions and services are transforming how consumers and business interact. As a substitute to traditional face-to-face dealing and paper transactions, online transactions provide greater user flexibility, less business overhead, and quicker response time for parties located throughout the world. However, these conveniences are inherently coupled with risks and security concerns because electronic documents can be easily modified and data storage centers are constantly at risk of hackers, both of which can compromise the validity of electronic documents.

To facilitate verification of electronic documents, a document can be digitally signed through a data encryption method, such as symmetric and asymmetric cryptography. With symmetric cryptography the two transacting parties use one private key to encrypt and decrypt the data. However, difficulties exist with distributing the key between the involved parties, and if the private key is uncovered the encrypted document can be compromised. Asymmetric cryptography, or public key cryptography, was created as a solution to this distribution problem. With public key cryptography, a user has a pair of cryptographic keys, one public key and one private key, both of which are related mathematically. A document encrypted with the public key can only be decrypted using the corresponding private key. Additionally, a document can be digitally signed using the private key. Anyone who has access to the public key can verify the sender signed the document and the document was not compromised.

However, a central problem with public key cryptography is proving that a public key is authentic and has not been tampered with or replaced by a third party. Additionally, public key encryption is susceptible to brute force attacks of repeatedly trying different keys until the appropriate key is uncovered. One solution to this vulnerability is to use a sealed registration document authority, which is a trusted third party responsible for verifying the identity of a user of the system and issuing a digitally sealed registration document, which is a signed block of data stating the public key belongs to that person, company, or other entity.

A user can also use a hash function to generate a digital fingerprint of the data. The hash value is a relatively small unique identifier of the document which can be easily reproduced. The sending party generates a hash of the data, and the receiving party can regenerate the hash of the document and compare the resulting hash value with the sending party's hash value to ensure the document was not changed. Additional information can be combined with the unique hash value to provide information on the document creation time (e.g. a timestamp and other relevant information, which can be digitally signed by the sending party and verified by the receiving party.

Over time, however, cryptographic keys can be broken. Authentication of digitally signed information relies upon the integrity of the cryptography used, which can be compromised over time and digital signatures alone cannot therefore meet the requirements for reliable long-term evidence of document integrity. Digital certificates can expire within a fixed time and usually must be revoked when they expire. Digital certificates can limit the durability of electronic data signed by the secret key, a revocation list has to be managed, and digital certificate maintenance involves considerable management and cost overhead.

Before a digital certificate can be used reliably, a relying party needs to receive a correct copy of the certificate for the certificate authority and must trust the certificate. The relying party must also trust the certificate authority has properly checked the identity of the key-holder and the validity of the public key before issuing a certificate. In the event an attacker subverts the certificate authority into issuing a certificate for a compromised public key, the attacker could mount a man in the middle attack as if the certificate scheme were not used at all. In addition, the relying party must trust the certification authority itself and that the certificate can be relied on for that business purpose.

Furthermore, most digital signatures rely in a series of certificates, resulting in a certification chain. Revocation of any one certificate in the chain means that a digital signature relying on any certificate in that chain cannot be validated. And although time information can be added, there is no guarantee the time can be trusted. Digital signatures and public key infrastructures do not include a trusted time that can be validated at any time in the future. Additionally, when using certificates, the relying party does not have a direct trusted relationship with the originating party.

It is desirable for a party to create an electronic document seal which can validate the authenticity of the data and last for a long period of time. Changes to the data should be immediately detectable to demonstrate the data is in its original form. Digital signatures can assist in validating who is involved (e.g. the transacting parties) and what the original information or data was, but once the certificate chain is broken or becomes invalid, or the trust in any one of the certificates in the chain becomes uncertain, the system can no longer verify this information. It is desirable for a seal to endure even if a public key is broken and to provide reliable evidence of when the document was created and/or sealed. It is desirable for a direct trust relationship to exist between a user and other parties, without requiring a trust in any third party.

### SUMMARY

Advantageously, the techniques described herein provide a sealing method for the electronic binding of evidence information regarding who is involved (e.g. the transacting parties), what the original information or data was, when the data was created and other data that provides evidence about the data and the context in which it was used, in totality this is called the evident seal. The evidence seal provides non-repudiation of data and the context in which data was used. The identity and context of the user at the time the data is sealed can be preserved. Evidence relating to document creation and integrity can be clearly and unambiguously displayed to a relying party, and whenever the data is sent, copied, or moved, the authenticity can still be independently verified. The evident seal is stored in an evidence archive and the evidence archive is itself sealed to provide non-repudiation of the evidence archive. The evidence archive can be resealed using the latest strength cryptography to ensure the evidence endures for a long period of time. Protected data can be independently validated at any time in the future. Once sealed, protected data cannot be repudiated. For example, a party to a contract or a communication can not later deny the validity of the contract or of the communication that they originated. In today's global Internet economy, where face-to-face agreements are often not possible, businesses and regulators are increasingly aware of the vital need for electronic non-repudiation.

In one aspect, there is a method including receiving a plurality of seals. The method includes each seal having a seal of electronic data generated using a first sealing algorithm and storing the plurality of seals in an archive of seals. The method further includes sealing the archive of seals with a second sealing algorithm to generate a second seal.

In another aspect there is a system including a data store which can be configured to receive one or more seals, where each seal can include electronic data generated by using a first sealing algorithm. The system includes a data store which can store the one or more seals in an archive of seals. The system further includes a data store which can seal the archive of seals with a second sealing algorithm to generate a second seal.

In another aspect there is a program product, tangibly embodied in an information carrier, the computer program product including instructions which can be operable to cause a data processing apparatus to receive one or more seals, each seal including electronic data generated using a first sealing algorithm. The program product includes instructions which can be operable to store the one or more seals in an archive of seals. The program product further includes instructions which can be operable to seal the archive of seals with a second sealing algorithm to generate a second seal.

In another aspect there is a system including a means for storing one or more seals, each seal including electronic data generated using a first sealing algorithm. The system includes a means for sealing the archive of seals with a second sealing algorithm to generate a second seal.

In another aspect there is a method including receiving a signal associated with a second user indicative of a request to seal a first sealed electronic data from a first user. The method includes the first sealed electronic data including a first seal generated at a first sealing time, authenticating the identity of the first user, the second user, or both and generating a second seal at a second sealing time occurring after the first sealing time. The method further includes the second seal including information about the first sealed electronic data, evidentiary metadata, and information about the first user, the second user, or both.

In another aspect, there is a system including one or more computing devices configured to receive a signal associated with a second user indicative of a request to seal a first sealed electronic data from a first user, wherein the first sealed electronic data includes a first seal generated at a first sealing time. The system includes one or more computing devices which can authenticate the identity of the first user, the second user, or both. The system further includes one or more computing devices which can generate a second seal at a second sealing time occurring after the first sealing time, wherein the second seal can include information about the first sealed electronic data and information about the first user, the second user, or both.

In another aspect there is a computer program product, tangibly embodied in an information carrier, the computer program product including instructions being operable to cause a data processing apparatus to receive a signal associated with a second user indicative of a request to seal a first sealed electronic data from a first user, wherein the first sealed electronic data includes a first seal generated at a first sealing time. The computer program product can include instructions being operable to authenticate the identity of the first user, the second user, or both. The computer program product can further include instructions being operable to generate a second seal at a second sealing time occurring after the first sealing time, wherein the second seal includes information about the first sealed electronic data and information about the first user, the second user, or both.

In another aspect there is a system including a means for receiving a signal associated with a second user indicative of a request to seal a first sealed electronic data from a first user, wherein the first sealed electronic data includes a first seal generated at a first sealing time. The system includes a means for authenticating the identity of the first user, the second user, or both. The system further includes a means for generating a second seal at a second sealing time occurring after the first sealing time, wherein the second seal includes information about the first sealed electronic data and information about the first user, the second user, or both.

In another aspect there is a method including receiving a request associated with a user to generate a seal of a first electronic data, the first electronic data being associated with a second electronic data. The method includes generating a first unique identifier of the first electronic data and generating a second unique identifier of the second electronic data. The method further includes generating the seal of the first electronic data including the first unique identifier and second unique identifier.

In another aspect there is a system including one or more computing devices configured to receive a request associated with a user to generate a seal of a first electronic data, the first electronic data being associated with a second electronic data. The system includes one or more computing devices configured to generate a first unique identifier of the first electronic data and generate a second unique identifier of the second electronic data. The system further includes one or more computing devices configured to generate the seal of the first electronic data including the first unique identifier and second unique identifier.

In another aspect there is a computer program product, tangibly embodied in an information carrier, the computer program product including instructions being operable to cause a data processing apparatus to receive a request associated with a user to generate a seal of a first electronic data, the first electronic data being associated with a second electronic data. The computer program product includes instructions being operable to generate a first unique identifier of the first electronic data and generate a second unique identifier of the second electronic data. The computer program product further includes instructions being operable to generate the seal of the first electronic data including the first unique identifier and second unique identifier.

In another aspect there is a system including a means for receiving a request associated with a user to generate a seal of a first electronic data, the first electronic data being associated with a second electronic data. The system includes a means for generating a first unique identifier of the first electronic data and a means for generating a second unique identifier of the second electronic data. The system further includes a means for generating the seal of the first electronic data including the first unique identifier and second unique identifier.

In another aspect there is a method for registering a user including generating a license key and generating a user identification number. The method includes receiving a request indicative of creating a registration document, the request including a registration data and generating a registration document in response to the request indicative of creating a registration document. The method further includes receiving a request indicative of creating a seal of the registration document and generating a seal of the registration document in response to the request indicative of creating a seal of the registration document.

In another aspect there is a system for registering a user including a registration authority configured to generate a license key. The system includes a registration system configured to generate a user identification number and receive a request indicative of creating a registration document, the request including a registration data. The registration system can further generate a registration document in response to the request indicative of creating a registration document and receive a request indicative of creating a seal of the registration document. The system further includes a manager configured to generate a seal of the registration document in response to the request indicative of creating a seal of the registration document.

In another aspect there is a computer program product, tangibly embodied in an information carrier, the computer program product including instructions being operable to cause a data processing apparatus to generate a license key and generate a user identification number. The computer program product includes instructions being operable to receive a request indicative of creating a registration document, the request including a registration data and generate a registration document in response to the request indicative of creating a registration document. The computer program product further includes instructions being operable to receive a request indicative of creating a seal of the registration document and generate a seal of the registration document in response to the request indicative of creating a seal of the registration document.

In another aspect there is a system including a means for generating a license key and a means for generating a user identification number. The system includes a means for transmitting a request indicative of creating a registration document, the request including a registration data and a means for generating a registration document in response to the request indicative of creating a registration document. The system further includes a means for transmitting a request indicative of creating a seal of the registration document and a means for generating a seal of the registration document in response to the request indicative of creating a seal of the registration document.

Any of the aspects above can include one or more of the following features. The archive of seals can be re-sealed with a third sealing algorithm to create a third seal. The second seal can be stored by a trusted party. The authentication information can be verified for a user. The authentication information can include a secret key, a community identifier, an individual identifier, or any combination thereof. The seal can include a text string, and external file, an HTML seal, an MHT seal, an XML seal, or an ASN.1 seal. The seal can be digitally signed. A first electronic data associated with a first seal in the plurality of seals can include a sealed document, personal information, a legal transaction, a medical document, multimedia data, or any combination thereof. The personal information can include a social security number, a license number, a passport, a birth sealed registration document, a credit card number, a bank account number, an email address, an identity card data, or any combination thereof. The legal transaction can include a contract offer, a contract acceptance, a goods transfer record, or any combination thereof. The multimedia data can include audio data, video data, graphics, or any combination thereof. The first and second sealing algorithms can include one or more hashing functions. The first sealing algorithm can be different from the second sealing algorithm.

A toolkit can be configured to securely store authentication information for a user. The toolkit can be further configured to generate a hash of the electronic data. A manager can be configured to create the one or more seals. A validation server can be configured to validate a seal. An evidence toolkit can be configured to receive a signal indicative of creating a seal, a signal indicative of validating a seal, a signal indicative of receiving information regarding a seal, or any combination thereof.

A second sealed electronic data including the second seal and the first sealed electronic data can be generated. The second sealed electronic data can be transmitted to the first user. The second sealed electronic data can be transmitted to a relying party. A request can be received associated with the first user, second user, or an additional user indicative of validating electronic data associated with the first sealed electronic data verifying the second sealed electronic data includes a first unique identifier, the first unique identifier being identical to the first sealed electronic data. The first sealed electronic data can be verified to include a second unique identifier, the second unique identifier being identical to the first sealed electronic data. The first sealed electronic data and/or the second sealed electronic data can include a seal and an electronic data.

The seal can be a text string, an external file, an HTML seal, an MHT seal, or an XML seal. The seal can be detached from the electronic data. The second user can be can be associated with a notary service. The application service of the first user, second user, or both can be identified. The application service can include a web portal. The first sealed electronic data includes a sealed document, a personal information, a legal transaction, a medical document, a multimedia data, or any combination thereof. The personal information can include a social security number, a license number, a passport, a birth sealed registration document, a credit card number, a bank account number, an email address, an identity card data, or any combination thereof. The legal transaction can include a contract offer, a contract acceptance, a goods transfer record, or any combination thereof. Multimedia data can include audio data, video data, graphics, or any combination thereof. The evidentiary metadata can include multimedia data. The multimedia data can include audio data, video data, graphics, or any combination thereof.

The evidentiary metadata can be an XML file. The evidentiary metadata can be associated with a style sheet indicative of displaying the XML file. The XML file, the style sheet, or both can be external files. The first user, the second user, or any additional user can register using a unique identifier. The unique identifier can be generated using a MAC address. The unique identifier can be encrypted.

The one or more computing devices can further be configured to receive a request associated with the first user, second user, or an additional user indicative of validating the electronic data. The one or more computing devices can further be configured to verify the second sealed electronic data includes a first unique identifier, the first unique identifier being identical to the first sealed electronic data. The one or more computing devices can further be configured to verify the first sealed electronic data includes a second unique identifier, the second unique identifier being identical to the first sealed electronic data. A data store can be configured to archive a first seal associated with the first sealed electronic data and a second seal associated with the second sealed electronic data.

The first electronic data can include an email and the second electronic data can include an attachment of the email. The second electronic data can include an external file. The seal can include an authentication information of the user, the first unique identifier, a sealing time, and an external reference associated with the second electronic data. The seal can include a reference data. The reference data can include a text string. The external reference can include the second unique identifier and an external reference to the second electronic data. The seal can include a plurality of external references. The external reference can be associated with evidentiary data. The evidentiary data can include a multimedia data. The multimedia data can include audio data, video data, graphics, or any combination thereof. The sealing time can be a trusted time.

The second electronic data can include a second seal. The second seal can include external references. A request associated with a second user indicative of validating the first electronic data can be received. The first unique identifier can be verified identical to the first electronic data, and the second unique identifier can be verified identical to the second electronic data. The first electronic data includes a sealed document, a personal information, a legal transaction, a medical document, a multimedia data, or any combination thereof. The seal can be stored separately from the first electronic data. The seal and the first electronic data can be stored in an electronic file. An API can be used to execute a command. The command can be operative of creating the seal of the first electronic data, validating the seal of the first electronic data, or extracting information from the seal of the first electronic data.

A validation server can be configured to receive a request associated with the first user or any additional user indicative of validating the first electronic data, verify the first unique identifier belongs to a first data which is identical to the first electronic data, and verify the second unique identifier belongs to a second data which is identical to the second electronic data. The one or more computing devices can be further configured to generate the seal are local to the user. A manager may not receive the first electronic data or second electronic data. A computer display can be configured to display the sealed first electronic data in a first area of the computer display and display the seal in one or more other areas of the computer display.

A request can be received to generate a second seal of the registration document, and a second seal of the registration document can be generated in response to the request to generate a second seal of the registration document. The registration data can include a user information, a community information, a registration authority information, a supplemental information, or any combination thereof. The user information can include a user identification, a user name, an email, or any combination thereof. The community information can include a community identification, a community name, or any combination thereof. The registration authority information can include a registration authority user identification, a registration authority user name, or any combination thereof. A public key and private key pair can be generated. The public key can be transmitted and the public key can be signed with the private key. The request indicative of creating a seal of the registration document can be signed with the private key. The private key can be stored in a wallet.

A one-time registration key can be generated. The request indicative of creating a seal of the document can include the one-time registration key. The registration document can be stored in a data store. The registration document can be associated with the license key. The seal of the registration document can be transmitted to a user.

The registration system can be further configured to receive a request to generate a second seal of the registration document. The manager can be further configured to generate a second seal of the registration document in response to the request to generate a second seal of the registration document. A data store can be configured to store the registration document. The registration system can include a web server and an evidence server.

Any of the aspects above can include one or more of the following advantages. The techniques described herein enable a seal that does not expire, allowing validation of electronic data any time in the future. The seal creates evidence of the electronic data originator, proof of time the electronic data is sealed, authenticity of the seal (e.g. through cryptographic code), and other evidentiary metadata which prevents repudiation of electronic data. The evidence defines a context in which the user claims a legal responsibility for their actions. The sealed electronic data is guaranteed to be authentic, changes are immediately detectable, and can be relied on when challenged. Organizations can be certain their documents (e.g. business transactions, web services, etc.) and communications (e.g. email, instant messages, etc.) will not be undetectably altered, thus protecting them both financially and legally. Seals are stored in a form facilitating clear and unambiguous presentation to everyday people, not just IT systems. The evidence provided in durable and evidence meta places the evidence in context and can prove intent. The registration process does not use digital certificates and consequently avoids the durability and maintenance limitations inherent with digital certificates. The system disclosed is designed around providing evidence about who is using the system, what the system is being used to accomplish, and what a user is legally responsible for with their actions. The intent of the user can be ascertained from the evidence to create the legal context. The evidence is durable and can last for months, years, decades, centuries.

### BRIEF DESCRIPTION OF THE DRAWINGS

The foregoing and other objects, features, and advantages of the present invention, as well as the invention itself, will be more fully understood from the following description of various embodiments, when read together with the accompanying drawings.

FIG. 1 is a block diagram of an exemplary system for seal creation and validation based on any underlying electronic data.

FIG. 2 is a block diagram of another exemplary system for seal creation, storage, and validation.

FIG. 3 is a block diagram of an exemplary web-based system for seal creation and validation.

FIG. 4A and 4B are sequence diagrams of a user registration process.

FIG. 4C is a screen shot of an exemplary registration document.

FIG. 5 is an exemplary data structure for a seal.

FIG. 6 is an example of a nested seal.

FIG. 7 is a screen shot of exemplary seal and verification displays.

FIG. 8 is a screen shot of an exemplary desktop file sealing display.

FIG. 9 is a flow chart depicting sealing of an archive of seals.

FIG. 10 is a flow chart illustrative of generating a seal comprising evidentiary metadata.

FIG. 11 is a screen shot of an exemplary display for a document with multiple seals.

FIG. 12 is a block diagram of an exemplary system for notarizing a seal.

FIG. 13 is a flow chart illustrative of sealing a document including one or more additional documents.

### DETAILED DESCRIPTION

Sealing methods and systems have been created to allow an originating party to create a seal which can be later verified by a relying party. For example, see WO 2004/012415, the disclosure of which is herein incorporated by reference. However, the underlying algorithms and processes utilized by such sealing methods and systems can vary. The description disclosed herein provides for sealing methods and systems which capture additional evidentiary metadata, can be use for unique applications, and preserve the lifetime of generated seals and evidentiary metadata.

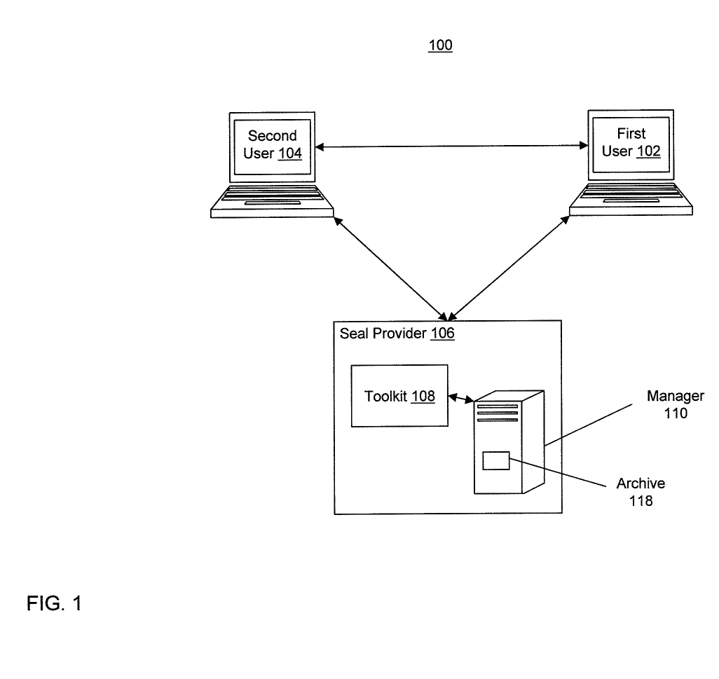

FIG. 1 is an overview diagram of an exemplary sealing system 100 which includes a first user 102 (e.g., a communication device used be a person to view and input data and/or a user using such a device) and a second user 104. The first user 102 can be the originating party which requires a seal to be created for an electronic data (not shown). The second user 104 can be a party requiring validation of the seal of the electronic data. The first user 102 and second user 104 are in communication with a seal provider 106. The seal provider 106 includes a toolkit 108 and a manager 110. The toolkit 108 receives a request from a user (e.g. the first user 102) to create a seal of an electronic data. The toolkit 108 can reside, for example, with the first user 102, or be in communication with the first user 102 over an internet, intranet, and/or the like. The toolkit 108 generates a unique hash value of the electronic data (e.g. using the secure hash algorithm SHAL defined in FIPS 180-1, SHA-256, SHA-512 etc.). As described in more detail below, the toolkit 108 signs the hash data using a private key. The manager 110 is in communication with the toolkit 108, and receives the signed hash data from the toolkit 108. The manager 110 creates the seal of the electronic data using the signed hash data and adding additional data, such as a timestamp from a trusted source, and stores the seal of the electronic data in a data store, to create an archive 118 of electronic seals. As described in more detail below, the archive 118 is also sealed to maintain the integrity of the store seals. There can be multiple managers 110 in the sealing system 100. The manager 110 transmits the seal to the first user 102.

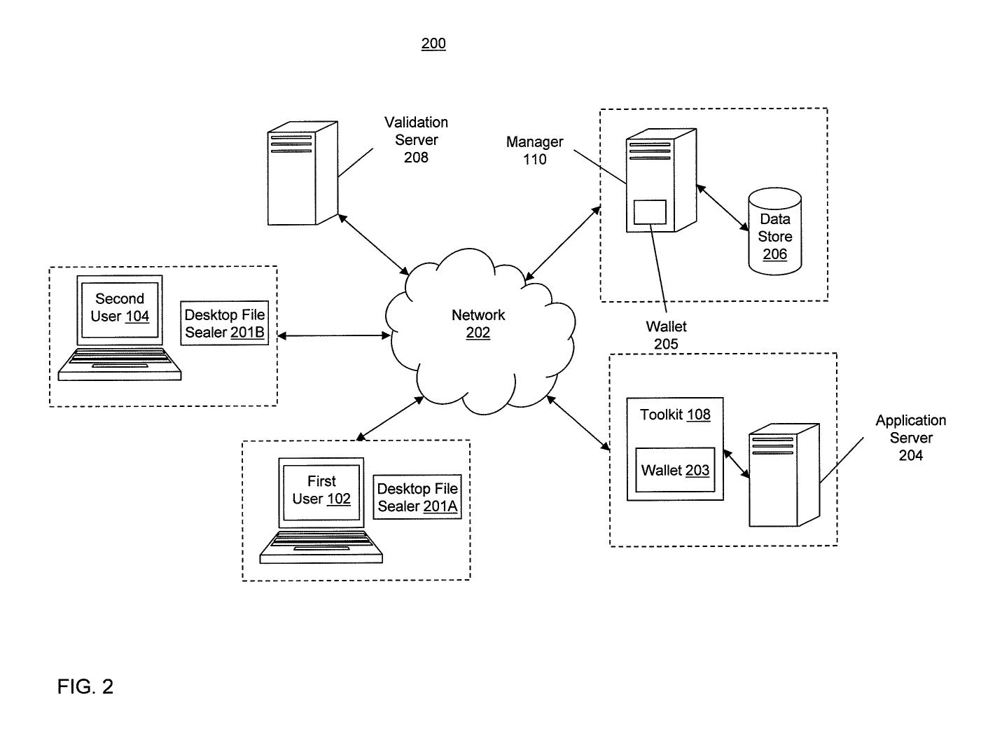

When the first user 102 sends a request to the seal provider 106 to create a seal, the first user 102 identifies the electronic data for which the seal is to be created. The electronic data can be a specific type of electronic document, such as a word processing document, a spreadsheet and/or a slide presentation, e-ticket, online purchase receipt, goods transfer record, commercial contractual offer, commercial contractual acceptance, email, email attachments, any type of file, medical record, security clearance, medical prescription, electronic vote, screen shot, and any other electronic data. The term document is used herein interchangeably with electronic data, and unless the context dictates otherwise, the term document should be considered as representing any sealable electronic data. The second user 104 can receive the sealed electronic data (e.g., a copy of the original electronic data and the generated seal) from the first user 102 and request validation of the electronic data from the seal provider 106. The seal provider 106 receives the validation request from the first user 102 and validates the sealed electronic data. The seal provider 106 returns the result to the second user 104. The sealing system 200 of FIG. 2 is a more detailed block diagram that includes some of the components of the sealing system 100 of FIG. 1. The first user 102 and/or the second user 104 may use a desktop file sealer 201A. The desktop file sealer 201A, described in more detail below, includes a user interface that allows a user to load documents into the desktop file sealer 201A, to enter evidence metadata, and/or to make a request to perform the sealing operation. The first user 102 and second user 104 are connected to the other components of the sealing system 200 over a communications network 202, such as the internet/intranet. The toolkit 108 is depicted as being included as part of an application server 204. The toolkit 108 is typically located at a convenient location near the data store of the electronic data that might be routinely sealed. However, the toolkit 108 can be located elsewhere, such as on a separate server (not shown). The toolkit 108 can also be local to the user, e.g. the desktop file sealer 201A, 201B can incorporate a toolkit 108, so the electronic data being sealed by the first user 102 or second user 104 does not have to leave the user's computer. The toolkit 108 includes a wallet 203. The wallet 203 can include a private key for asynchronous encryption, a user ID, user name, and/or the like. The toolkit 108 is in communication with the network 202 and the application server 204. The manager 110 includes information (e.g. in the data store 206) about the user and the public key relating to the secret key held in the user's wallet. The public key is sealed with the user data as part of a sealed registration document for that user. The manager 110 is in communication with the network 202 and the data store 206. The manager 110 can, for example, create and store seals of electronic data. The validation server 208 is in communication with the network 202. The validation server can be, for example, validate a seal and its associated electronic data, independent from the manager 110, which has stored a copy of the seal.

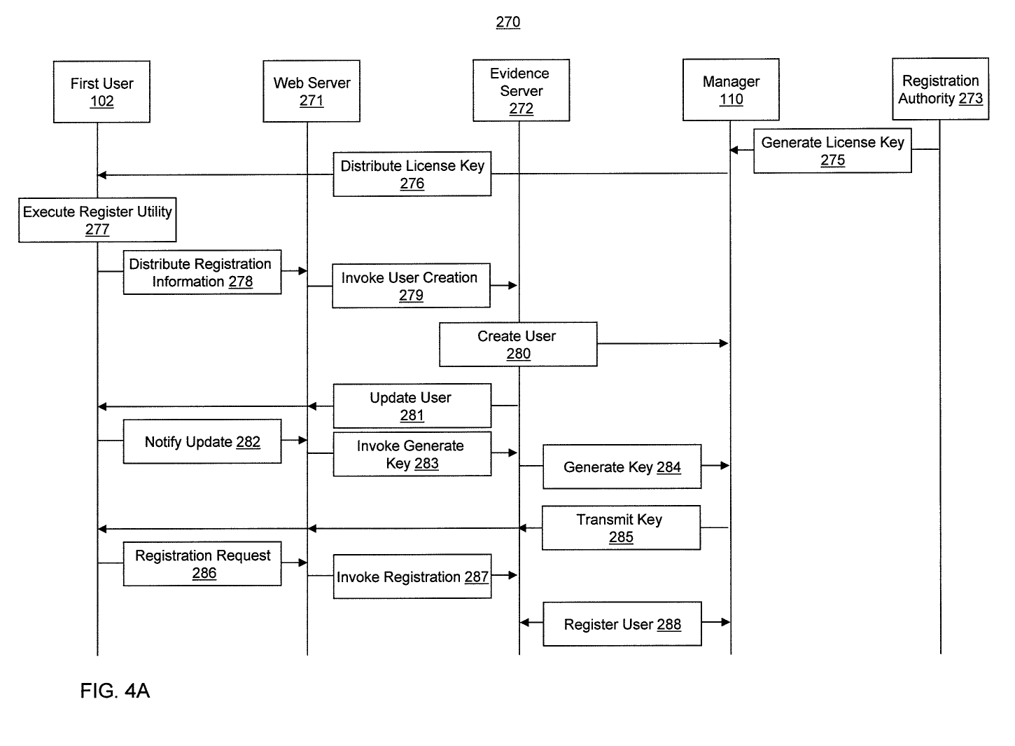

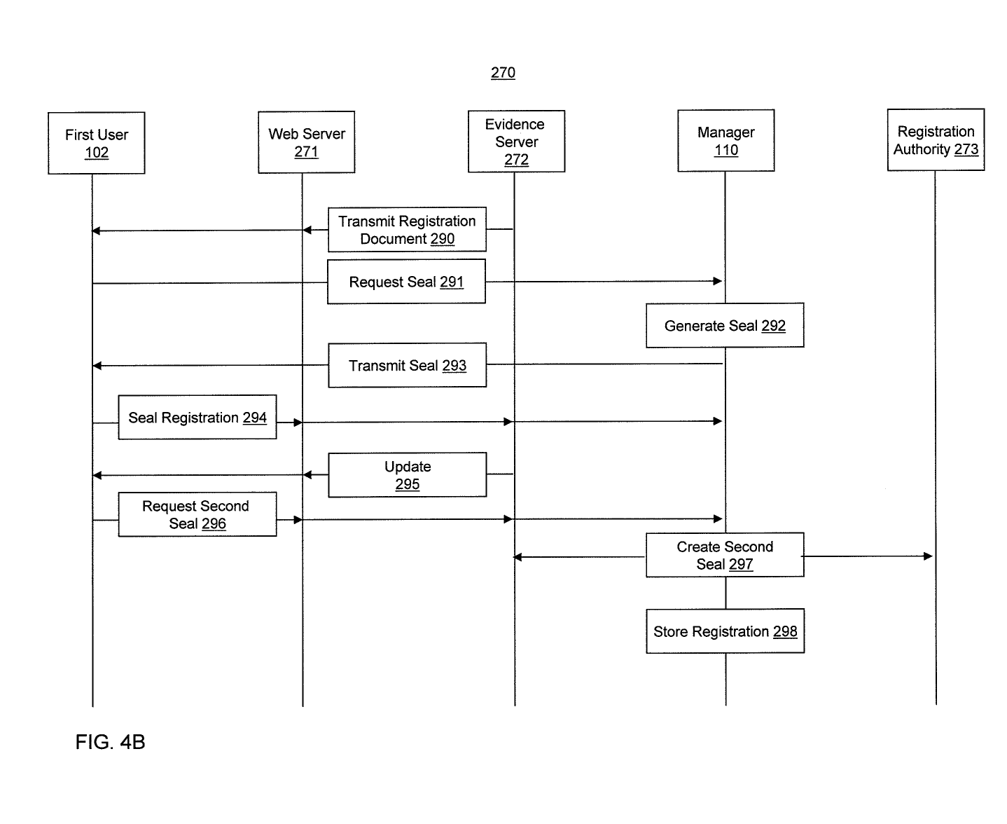

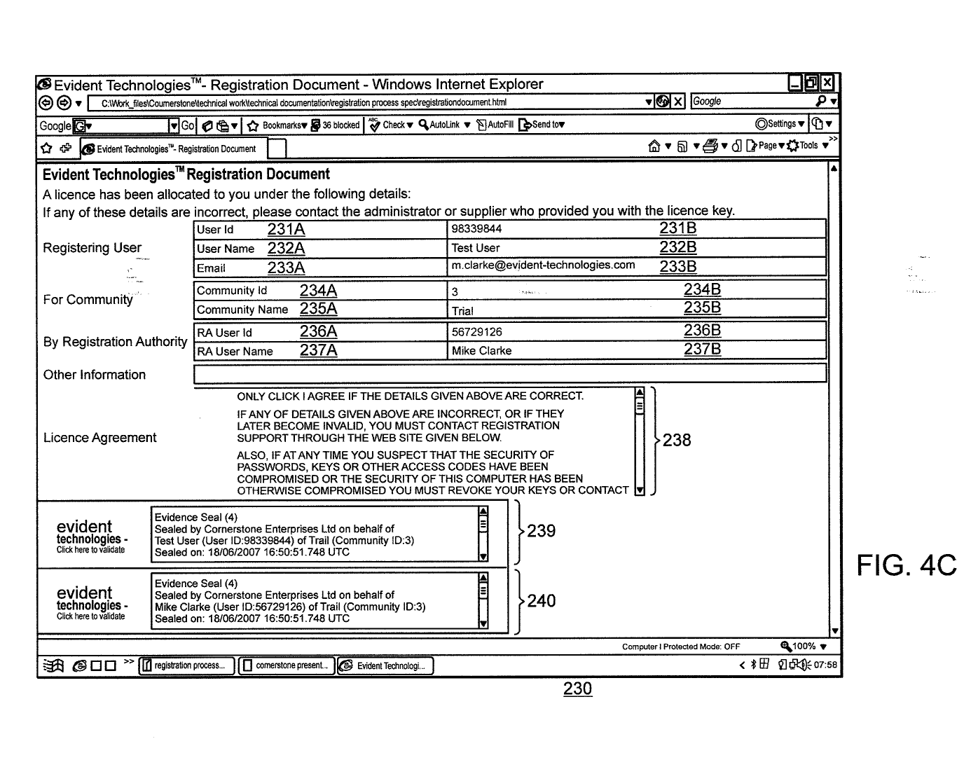

When, for example, a user installs a desktop file sealer 201A, 201B (the desktop file sealer can include a toolkit 108 and wallet 203), the user is given a user license and runs an installation program which generates public key and private key for that user. The user can use a random seed to generate the key pair, which can be an ID, a MAC address, or other unique identifier associated with that user to generate the public and private keys. The key can be cryptographically liked to hardware attributes of the installed system if desired. An individual user can register with the manager 110 using a secret key, a PC generated unique ID, a smart card, or other identifier of the individual user using the seal registration process administered by a registration authority (see FIG. 4A, 4B). The registration process produces a registration document which contains the registration details of the toolkit 108 (see FIG. 4C).

The toolkit 108 includes a wallet 203 (e.g. in the desktop file sealer 201A, 201B), the wallet 203 can include one or more private keys which can be associated with a particular user. The wallet 203 can have multiple private keys for different users within a community or for different communities and for different users within different communities. A toolkit 108 can store identifying information in the wallet 203 which identifies a user ID, name, community ID, user name, and other information which a particular private key is registered. For example, the toolkit 108 may contain a key to allow a user to sign a contract for a company and a key to sign a tax form as an individual. A user (e.g. the first user 102, second user 104) can have one key associated with multiple registrations to facilitate different sealing applications. In some embodiments, the same result can be achieved with multiple keys for a user, each key being associated with a different use. The wallet 203 can be encrypted using synchronous encryption, asynchronous encryption, or any other encryption method. The wallet 203 can be placed in a dedicated hardware component such as a smart card.

The toolkit 108 can transmit user information to the manager 110 for inclusion in the seal. A seal can include, as evidentiary metadata, the name of a toolkit 108, the identity of a toolkit 108, the user with whom the toolkit 108 is associated, and other data specific to the electronic data. For example, if a user (e.g. the first user 102 or second user 104) of an organization or community signs into an organization's network, the user's ID and name can be passed to the toolkit 108 and/or the manager 110 to provide more detail on their association with the organization. These and other parameters (e.g. evidence metadata) can be passed using, for example, System Assertion Markup Language (SAML). The toolkit 108 can sign the user information using the private key contained in the wallet 203.

The toolkit 108 can be a toolkit for an individual, for an office, for an organization, or any other party desiring to generate a seal. For example, the toolkit 108 can be integrated with an email server which can be used to seal emails leaving a company. The application server 204 can be an email server of the company, and the toolkit 108 can be connected directly to the email server. The wallet 203 can contain the keys associated with the company. The toolkit 108 can be configured to seal every email leaving the company, emails associated with a specific employee, emails associated with a group of employees, or any other user defined combination. The toolkit 108 receives the email from the email server, and generates a hash of the email. The toolkit 108 signs the hash, and transmits the signed hash and any other relevant evidentiary metadata to the manager 110. The manager 110 verifies the signed hash using the public key and registration document held in the data base for the user and generates a seal of the email (email seal). The manager 110 archives a copy of the email seal in the data store 206 for future access. The manager 110 transmits the email seal to the toolkit 118 that interacts with the application server 204 to email the sealed message to the intended recipient. The application server 204 can additionally archive the complete sealed message. Advantageously, the company can be certain that if the contents of the email are later altered, the archived copy of the email seal in the data store 206 can verify the email data is authentic long after the event and the manager 110 can retrieve the sealed email from the application server 204. For example, if the company sent an order confirmation with a specified price which is later changed by a third party, the company can verify what data is authentic by checking the seal and in the longer term resort back to the archived copy of the seal in the data store 206 to prove the actual accepted price (providing long term durable evidence). The sending party, receiving party, or any third party can verify the email was not altered.

As an example of operation of the system 200, the first user 102 can make a request to the toolkit included in the desktop file sealer 201A to generate a seal of an electronic data. The request includes a signed request using the appropriate secret key in the wallet 203 of the unique ID which is be stored in the wallet, the computed unique hash of the electronic data.

If the electronic data includes multiple documents (e.g., an email with attachments), the desktop file sealer 201A can generate a collection of unique hashes, which includes a unique hash for each document. The desktop file sealer 201A can compute an additional overall hash of the collection of unique hashes. The desktop file sealer 201A can electronically sign the overall hash using a cryptographic algorithm. For example, the toolkit of the desktop file sealer 201A can use the private key included in the wallet 108 of the desktop file sealer 201 A to sign the hash data. The public keys are associated with a user within a community, and the user's registration document is associated with the public key held with the database (e.g. the data store 206) of the manager 110. The toolkit of the desktop file sealer 201 A can transmit the signed hash data to the manager 110. The signed hash data can be transmitted with evidence metadata provided by the first user 102, such as information about the user (e.g. the first user or second user) and the requesting service (e.g. the desktop file sealer 201A). The signed hash data is transmitted over an encrypted link, such as a secure socket layer (SSL) connection, as a seal creation request to the manger 110.

The same process can apply with the toolkit 108, wallet 203 integrated with an application server 204. The registration process producing a sealed registration document that identifies the application by the user ID and user name in the sealed registration document. The manager 110 can verify that the requesting service (e.g. the toolkit 108 of the desktop file sealer 210A, 210B) is known and authorized. The manager 110 can, for example, perform a verification process to verify the toolkit 108 with the public key and sealed registration document of the toolkit 108. If, for example, the manager 110 determines the sealed registration document or the private key used to sign the seal request is invalid for that registered user, the manager 110 can abort the sealing process. A user cannot create a seal unless the key is valid and consistent with the sealed registration document. If the manager 110 determines the sealed registration document and private key used to sign the request are valid and correct for that user and community ID, the manager 110 can continue with the sealing process. The manager 110 adds a trusted timestamp indicative of the sealing time of the electronic data. The timestamp can be synchronized with the Coordinated Universal Time (UTC) acquired from the National Institute of Standards and Technology (NIST) Internet Time Service (ITS), the US Naval Observatory, the National Physical Laboratory (NPL), and other trusted time sources. The timestamp can be a mathematical combination (e.g. an average) of multiple time sources. The timestamp can be an independently kept high quality time source (e.g. using a trusted time calibration and audit service to keep the internal time of the manager 110 in sync with UTC time).

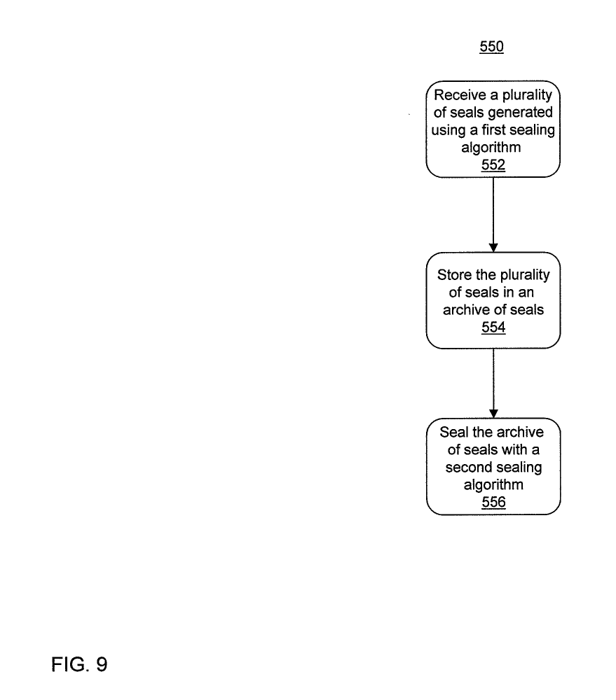

The manager 110 can bind evidence metadata, the signed hash, and the timestamp to create a seal, using the secret key of the manager 110. The seal can be stored in one or more archives (e.g. the data store 206). The archives are also sealed, which will be explained further with reference to FIG. 9. The manager 110 transmits the seal back to the requesting service (e.g. the toolkit 108, which can be located in the desktop file sealer 210A, 210B). The manager 110 can use a hardware security module when creating the seal. For example, the manager 110 can employ a FIPS 140-1 level 3 compliant hardware security module. The timestamp and seal generation processes can be performed within the hardware security module to provide higher levels of integrity. The hardware can support multiple cryptographic algorithms, resist attempted hacker attacks, perform secure processing, and/or the like.

The sealing system 200 can be used to protect electronic data in various applications. For example, a bank can seal and archive documents to eliminate paper copies. Paper documents can be scanned into a computer electronically, or scanned using other scanning devices, such as a copy machine, and the scanned data can be sealed by the toolkit 108 and manager 110. Because the seals are archived in the data store 206, advantageously the bank can discard paper copies because the sealed documents are archived and can be used to later verify the integrity of the scanned documents. For example, if one pixel is off for a particular image, the verification process will fail, indicating the sealed document has changed.

The sealing system 200 can also be used by a hospital to seal medical records. For example, the sealing system 200 can be used in conjunction with a medical device which outputs electronic data. The toolkit 108 can receive an electronic data when the electronic data is generated and seal the electronic data to allow any changes in the document to be detected. Advantageously, creating the seal for each medical document can create a log of event occurrences. For example, the doctors instructions can be sealed at time A, a prescription can be sealed at time B, the pharmacy record of filling the prescription can be sealed at time C, and the nurses instructions to the patient for taking the medication can be sealed at time D. This can create an evidenced timeline, which can allow the sequence of events to be verified at a later time. For example, it can be verified the prescription was filled only after the doctor wrote a prescription. Or, if there is a problem with a patient after receiving some medication, the seals and sealed data can be used to verify that the doctor wrote the correct prescription, and the pharmacy filled it correctly, but that the instructions to the nurse were incorrect.

The sealing system 200 can also be used to facilitate electronic voting. Instead of printing out paper copies of the vote to evidence what was recorded electronically, the electronic vote can be sealed to create the indisputable evidence. The seal can verify the integrity of the vote and, advantageously, if electronic votes can be trusted and verified, they can be submitted from anywhere, saving voters the time of going to the voting polls.

As an economic model, a user might pay for each seal generation at a remote host (e.g. the manager 110), creating a pay per seal business for the host/administrator of the sealing service. In another model, an administrator/ manufacturer can install a seal generator local to the customer with remote access to program allowance of a specified number of seals, where that customer pays an amount to be able to use the specified number of seals. Other like models are contemplated.

In the system 200, the second user 104 can validate a sealed electronic data using, for example, the validation server 208. The validation server 208 can be maintained by a third party to facilitate seal validation and integrity. The validation server 208 can use the public key of the manager 110 to validate seals created by a manager (e.g. the manager 110) or any other manager that is included in a cluster of evidence managers, or outside the cluster if it's specifically trusted by the manager of the validation service. If the seal can not be trusted, for example, (e.g. the public key associated with the private key of the manager 110 is retired) a message can be transmitted to the second user 104 indicative of the validation server 208 being unable to verify the seal. The message can instruct the second user 104 to contact the seal creating party (e.g., the manager 110) for further validation. If the Managers 110 Public key is retired, the electronic data can still be validated by going to the archives (e.g. the data store 206) and comparing the seal and its data being presented with the original seal stored in the archives. The archives are periodically resealed to constantly refresh the evidence with new and stronger algorithms. The archives can also be kept by a third party.

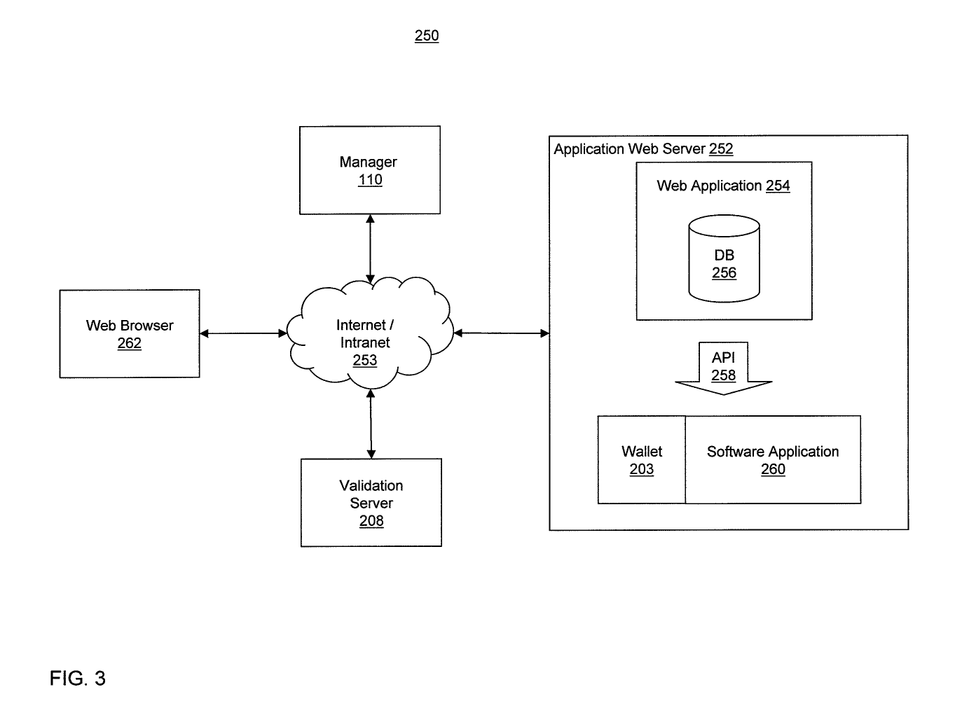

FIG. 3 is a diagram of an exemplary web-based sealing system 250. An application web server 252 is an example of an implementation of the toolkit 108 in a web server environment. Using an internet/intranet 253, the application web server 252 is in communication with the manager 110, which creates the seals of electronic data. The application web server 252 includes a web application 254. The web application 254 handles user requests to the application web server 252. The web application 254 has a database 256 to store necessary programs for the web application 254. The web application 254 uses an application programmer interface (API) 258 to communicate with a software application 260. The API 258 includes commands to, for example, create a seal, validate a seal, get seal information, get the number of seals in a document, extract a file from a seal, and/or the like. The software application 260 can receive calls using the API 258 and perform the necessary computation and processing to satisfy the request. The wallet 203 can securely hold information needed to authenticate a registered user (e.g. a first user 102 or a second user 104 from FIG. 1), validate the seal, and/or the like. A user can access the web application 254 using a web browser 262. The validation server 202 can be a public web service for independent validation of seals. In some embodiments of the web server sealing system 250, the application web server 252 (e.g. the toolkit 108) can be used with a local manager 110 and a local validation server 208. For example, the application web server 252 the evidence manager 110 and the validation server 208 can all be part of the same server device, and/or their functions can be distributed among co-located servers in a server farm or servers connected via a local communication channel, such as a LAN.

The API 258 can be supported on multiple platforms. For example, the API 258 can run on the Windows NT operating system, Windows 2000 operating system, Windows 98 operating system, Windows Me operating system, Windows XP operating system, and/or the like. Windows is a registered trademark of Microsoft Corporation in the United States and other countries. The API 258 can run on Unix, Solaris, and Linux implementations. The API 258 may be called from multiple programming environments. For example, the API 258 may be called using Java, Active Server Pages using VBScript or Jscript, Perl, PHP, Visual Basic, Delphi, C++, Windows native dynamic libraries (DLL) interface, Linux/Unix shared object interface, and/or the like.

Seals can be generated in multiple formats, such as text, HTML, MHT, XML detached files, and/or the like. The API 258 functions can include an EVIDENCE_CreateSeal call, which can create a seal for a given electronic data. The seal can be pre-formatted for presentation (e.g. text, HTML, XML, and/or the like). The inputs which can be used with EVIDENCE_CreateSeal are listed below in TABLE 1.

TABLE 1

| Parameter | Description |
|---|---|
| pEVIDENCEUserID | The registered User ID. |
| pEVIDENCECommunityID | The registered Community ID. |
| pBuffer | Pointer to the data to be sealed. |
| nBufLength | Length of data buffer |
| nDataType | Type identifier for the data format. |
| nFormat | Format of returned seal. |
| pControl | Control string for seal creation |
| pRefData | Pointer to and evidence metadata that is to be |
| | added to seal |
| pExternalFile | Pointer to additional files to be hashed. |
| | Then the hash value, file name and path |
| | details are to be added to seal. |
| pActionFlag | The pActionFlag can be set to 1 to zip the |
| | seal with all the additional files as indicated |
| | in pExternalFile. |

Referencing TABLE 1, the “Parameter” column lists the parameter name of a particular input which can be used with the EVIDENCE_CreateSeal method. The “Description” column provides a brief description of the corresponding parameter. The parameters “pControl,” “pRefData,” “pExternalFile,” and “pActionFlag” can be set to NULL (e.g. to indicate the parameter is not required, the default settings should be used instead, and/or the like). The outputs which can be returned are indicated in TABLE 2.

TABLE 2

| Output | Description |
|---|---|
| nSealLength | Length of seal output. |
| PSeal | Pointer to seal |
| pErrorText | Pointer to error text (if function returns error) |

Referencing TABLE 2, the “Output” column lists the name of a particular output which can be outputted when the EVIDENCE_CreateSeal method is invoked. The “Description” column provides a brief description of the corresponding output. The EVIDENCE_CreateSeal method can return EVIDENCE_ERR_NOERROR if the seal is created, otherwise an error can be included in the pErrorText.

The API 258 functions can include an EVIDENCE_ValidateSeal call, which can validate a seal (e.g. including the seal header information) for a given electronic data. If, for example, the seal alone and no data is submitted, the application web server 252 can only validate the seal. The inputs which can be used with EVIDENCE_ValidateSeal are listed below in TABLE 3.

TABLE 3

| Parameter | Description |
|---|---|
| Buffer | Pointer to a copy of the original data that was sealed. |
| BufLength | Length of data buffer |
| DataType | The type of data. |
| Seal | Pointer to seal |
| SealLength | Length of seal. |
| Format | Format of seal. |
| ExternalPointer | Path of each additional file. |

Referencing TABLE 3, the “Parameter” column lists the parameter name of a particular input which can be used with the EVIDENCE_ValidateSeal method. The “Description” column provides a brief description of the corresponding parameter. The parameter “Buffer” can be set to NULL if no data is submitted. The parameter “External Pointer” can be set to NULL if the external pointer is not known, e.g. there are no externally referenced files. The output for the EVIDENCE_ValidateSeal can be “ErrorString” which is a pointer to error text if the EVIDENCE_ValidateSeal returns an error. Otherwise, the EVIDENCE_ValidateSeal method can return EVIDENCE_ERR_NOERROR if the seal is validated. If the return is not EVIDENCE_ERR_NOERROR, the seal may fail to validate and the ErrorString may include an error message.

The API 258 functions can include an EVIDENCE_ValidateSealNoData call, which can validate a seal (e.g. including the seal header) without checking the data hash in the seal. The input parameters can be: “Seal” which is a pointer to the seal, “SealLength” which is the length of the seal, “Format” which is the form of the seal, and/or the like. The output can be “ErrorString” which is a pointer to error text if the EVIDENCE_ValidateSealNoData returns an error. Otherwise, the EVIDENCE_ValidateSealNoData method can return EVIDENCE_ERR_NOERROR if the seal is validated. If the return is not EVIDENCE_ERR_NOERROR, the seal may fail to validate and the ErrorString may include an error message.

The API 258 functions can include an EVIDENCE_CreateFileSeal which can create a detached seal for a given electronic data (e.g. a data file). The inputs which can be used with EVIDENCE_CreateFileSeal are described below in TABLE 4.

TABLE 4

| Parameter | Description |
|---|---|
| PEVIDENCEUserID | The registered User ID. |
| pEVIDENCECommunityID | The registered Community ID. |
| PFilepath | Pointer to the file to be sealed to be sealed. |
| PnSealLength | Length of Seal returned |
| NSealFormat | Format of returned seal. |
| PControl | Control string for seal creation. |
| pRefData | Pointer to and evidence metadata that is to be |
| | added to seal. |
| pExternalFile | Pointer to additional files to be hashed. |
| | Then the hash value, file name and path |
| | details are to be added to seal. |
| pActionFlag | The pActionFlag should be set to 1 to zip |
| | the seal with all the additional files as |
| | indicated in pExternalFile. |

Referencing TABLE 4, the “Parameter” column lists the parameter name of inputs which can be used with the EVIDENCE_CreateFileSeal method. The “Description” column provides a brief description of the corresponding parameter. The parameter “PControl” can be set to NULL to use default settings. The parameters “pRefData,” “pExternalFile,” and “pActionFlag” can be set to NULL if not required. The outputs which can be used with EVIDENCE_CreateFileSeal are listed below in TABLE 5.

TABLE 5

| Output | Description |
|---|---|
| pnSealLength | Length of seal output. |
| pSeal | Pointer to seal |
| pErrorText | Pointer to error text (if function returns error) |

Referencing TABLE 5, the “Output” column lists the name of a particular output which can be outputted when the EVIDENCE_CreateFileSeal method is invoked. The “Description” column provides a brief description of the corresponding output. The EVIDENCE_CreateFileSeal method can return EVIDENCE_ERR_NOERROR if the seal is created, otherwise an error can be included in the pErrorText output.

The API 258 functions can include an EVIDENCE_ValidateFileSeal method which can validate a seal created with the EVIDENCE_CreateFileSeal method. The inputs which can be used with the EVIDENCE_ValidateFileSeal are listed below in TABLE 6.

TABLE 6

| Parameter | Description |
|---|---|
| pFilepath | Pointer to a copy of the original file. |
| PSeal | Pointer to buffer containing seal |
| NsealLength | Length of seal. |
| NsealFormat | Format of seal. |
| ExternalPointers | Set pf Pointers to each additional files. |

Referencing TABLE 6, the “Parameter” column lists the parameter name of parameters which can be used with the EVIDENCE_ValidateFileSeal method. The “Description” column provides a brief description of the corresponding parameter. The output which can be used with EVIDENCE_ValidateFileSeal can be “pErrorString” which is a pointer to error text. EVIDENCE_ValidateFileSeal can return EVIDENCE_ERR_NOERROR if the seal is validated. If, for example, a value other than EVIDENCE_ERR_NOERROR is returned, the “pErrorString” output can include an error message.

The API 258 can include an EVIDENCE_GetNumberOfSeals method, EVIDENCE_GetNumberOfSealsInBuffer method, or another method to get the number of seals in a sealed document. The parameter can be “pszSealedDocument” which is a pointer to the sealed document file or sealed electronic data buffer. The outputs can be “nSeals” which is the number of seals, “pErrorText” which is the error text string on failure, and/or the like. The method to get the number of seals can return EVIDENCE_ERROR_NOERROR on success, and nSeals can include the number of seals (e.g. 0, 1, etc.). If the method fails, pErrorText can include an error message.

The API 258 can include an EVIDENCE_GetSealInfo method, EVIDENCE_GetSelaInfoFromBuffer, or another method to get information (e.g. reference data, user name, etc.) form a seal in a sealed document. The inputs to the method are described in TABLE 7.

TABLE 7

| Parameter | Description |
|---|---|
| InfoId | Identifier for required information. |
| SealedDocument | Pointer to sealed document. |
| SealIndex | Zero based index of seal to interrogate. |
| Control | Control string. |

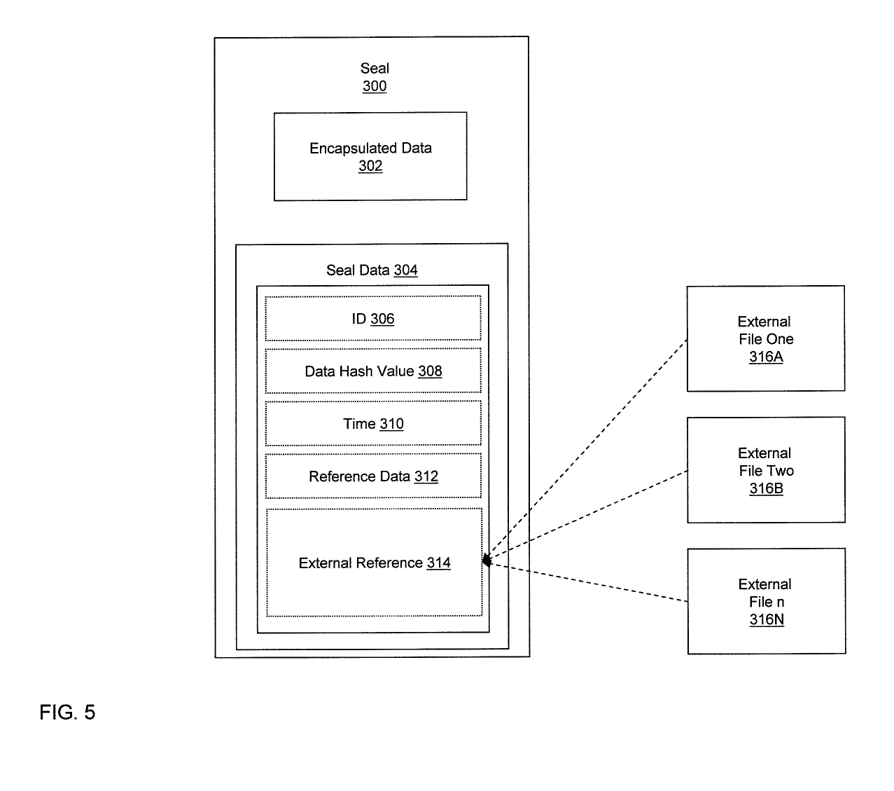

Referencing TABLE 7, the “Parameter” column lists the parameter name of a particular input which can be used with the method. The “Description” column provides a brief description of the corresponding parameter. The “InfoID,” for example, could be set to 1 to return the user reference data from the seal (this will be described in more detail with reference to FIG. 5). The “Control” can be set to NULL if there is no control string. The outputs can include “ReturnedInfo” which is a pointer to the returned data, and “ErrorString” which is a pointer to error text. On success, the method can return EVIDENCE_ERR_NOERROR and include information in “ReturnedInfo.” For an error, the error message can be included in “ErrorString.”

The API 258 can include an EVIDENCE_ExtractFileFromSeal method, which can extract a copy of a file that was sealed (e.g. an external reference which will be discussed further in conjunction with FIG. 5). The method can take as inputs “pFile” which is the full filename of the sealed file, “pOutFile” which is the full filename of an extracted file, and/or the like. The output can be “pErrorText” which is a pointer to error text. On success, the EVIDENCE_ExtractFileFromSeal method can return EVIDENCE_ERR_NOERROR on success. If there is an error, “pErrorText” can include an error message.

FIG. 4A and 4B are sequence diagrams of an exemplary user registration process 270. The toolkit (e.g. a toolkit 108 of a desktop file sealer 201A, 201B of FIG. 2) can use a self signed public key over an encrypted link to transmit the public key associated with the private key stored in the toolkit 108 to the manager 110 to register a user (e.g. the first user 102 or second user 104), with the user registration process 270. The user registration process 270 produces a sealed registration document. A sealed registration document (see FIG. 4C) is generated by the registration process 270, which can be used to determine whether a manager 110 or a toolkit 108 is valid. A sealed registration document can be stored in the data base (e.g. data store 206) of the manager 110 together with the public key of the user pertinent to the registration document. For example, the toolkit 108 can use the private key included in the wallet 203 to sign information (e.g. a generated hash of an electronic data) and transmit the signed hash to the manager 110. The manager 110 can use the public key and registration document held in the database associated with the toolkit 108 to verify the toolkit 108 used a valid private key to sign the data transmitted to the manager 110. Advantageously, this verifies the toolkit 108 is valid and generated the hash of the electronic data.

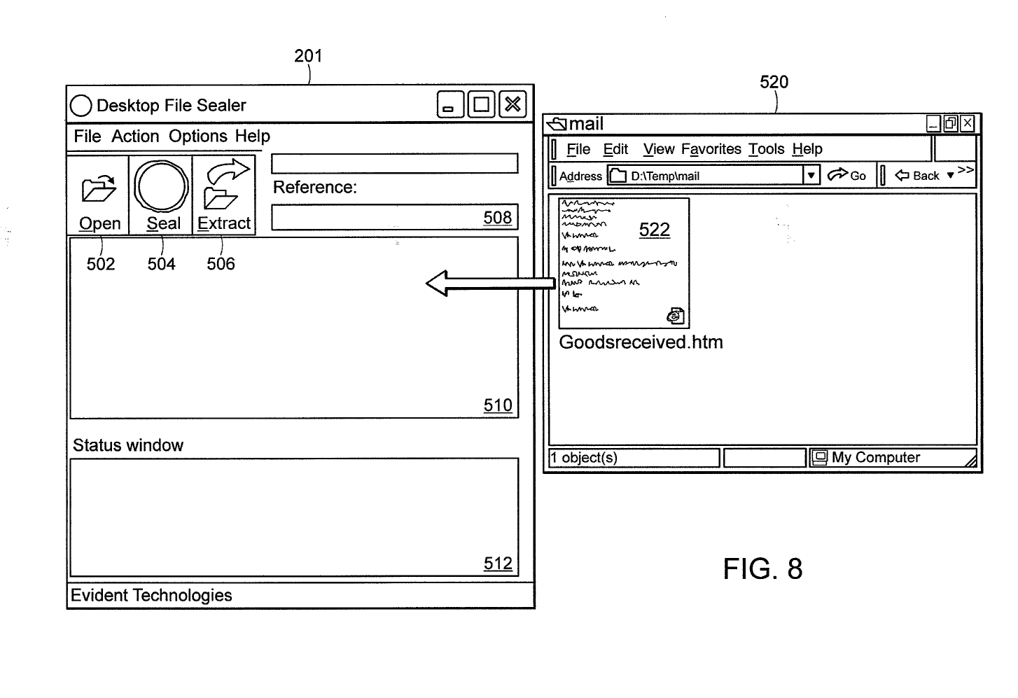

The first user 102 registers with the manager 110. There can be multiple managers, each manager 110 including a unique timestamp machine. For multiple managers, a database (e.g. the archive 118 of FIG. 1, data store 206 of FIG. 2) can be shared and synchronized across the managers. Sharing the database can allow a user (e.g. a first user 102 or any additional user) to use a different manager if the user's manager is out of service. For example, if a user's manager crashes, the user's toolkit can switch the user to a different manager which can access the user's information in the centralized database. A user can make a request to the manager 110 through a desktop file sealer (see FIG. 8) by dragging and dropping a file into the desktop file sealer and invoking the sealing process. The first user 102 can be an individual or an application. For example, the first user 102 can use a desktop file sealer (see FIG. 8) which comprises a toolkit and a wallet. A web server 271 is in communication with an evidence server 272. In some embodiments, the web server 271, evidence server 272, and manager 110 can be located on the same server device. The first user 102 communicates with the evidence server 272 using the web server 271. The web server 271 is a web server with which the registration authority 273 interacts to facilitate registering a user within a particular community. For example, a company can have a registration authority 273 to administer user IDs for the employees within the company community. The evidence server 272 is the process which performs the user registration.

The manager 110 can determine which private key was used to send a seal request. The private key can identify which toolkit (e.g. the toolkit 108) sent the request. The manager 110 receives information about the user (e.g. the user 102) from the seal request, and the manager 110 can verify the user information is valid and authorized to request a seal. The user information can be stored in a registration document (not shown). The registration document contains identifying information pertaining to a toolkit. The registration document can be stored in a database (e.g. the archive 118). For example, a company can maintain a database for the entire company, with multiple managers distributed throughout the company sharing a synchronized database. As another example, the database and managers can be part of a global service provided over a communication network, and a company makes requests for seals to the global service. The registration authority 273 can be part of a global sealing service. For example, a company can use a global sealing service and have a registration authority 273 located at the company to administer the users within the work community.

In the registration process 270, the registration authority 273 generates a license key (275). For example, the registration authority 273 can set up a license key which generates a license number within a community. License information (e.g. the license number, user name, capability flags, etc.) can be stored in the database (e.g. the archive 118) of the manager 110. The manager 110 distributes the license key to the first user 102 (276). The user can initialize the license by executing the register utility 277. To execute the register utility 277, the user can be prompted to enter identifying information, such as a community ID, the license key, and an email address. The first user 102 generates a public and private key pair (e.g. using a toolkit of a desktop file sealer as described in FIG. 8). The keys can be used to sign information transmitted from the user. The private key can be stored locally in the wallet of the first user 102. The first user 102 transmits the registration information 278 to the web server 271 using, for example, http-post. The registration information 278 can include the first user's 102 public key and community ID. The first user 102 can sign the public key with the secret private key of the first user 102. Signing the public key allows the manager 110 to verify the originating toolkit is in possession of the private key. The web server 271 invokes (279) the user creation process 280 at the evidence server 272. The web server 271 transmits the registration information 278 (e.g. the user's public key, community ID, license key, etc.) to the evidence server 272. The evidence server 272 creates a user ID. The information generated during the create user process 280 and other user details can be stored in the database of the manager 110. The stored information is associated with the license key in the database.

The evidence server 272 updates the user (e.g. the first user 102) (281) using, for example, an http-post. The update includes the user ID and community ID. The update is transmitted to the first user 102 (e.g. the toolkit of the first user 102) through the web server 271. The first user 102 can store the user ID in the wallet of the desktop file sealer. The first user 102 notifies the web server 271 of a successful update (282). The notification can include the community ID, user ID, license key, and email address of the first user 102. The notification can be transmitted to the web server using, for example, http-post. The web server 271 invokes (283) the generate key process 284. In this example, the key is a one-time key created to ensure the registration process is only executed once by the first user 102. The evidence server 272 generates the one-time key (284). The evidence server 272 verifies the evidence server 272 is for the first user's 102 community ID. The evidence server 272 associates the one-time key with the first user's 102 license key in the database of the manager 110. The evidence server 272 transmits the one-time key (285) to the first user 102 via the web server 271 using, for example, http-post.

The first user 102 transmits a registration request (286) to the web server 271. The registration request includes information about the first user 102 necessary to generate a registration document, such as the one-time key, user ID, user name, email, community ID, registration authority user ID, registration authority user name, and/or the like. The registration request can be transmitted using http-post. The registration request can be sealed with the secret key in the wallet of the first user 102. The web server 271 invokes the register user process 288 (287). The evidence server 272 and manager 110 interact to register the user and generate the registration document 288. The user details in the registration document (e.g. the one-time key, user ID, user name, email, community ID, registration authority user ID, and registration authority user name) are associated with the license key in the database of the manager 110. The manager 110 can use the stored registration document to verify signed requests from the first user 102 and to create a first seal for the user ID of the first user 102.

The evidence server 272 transmits the registration document to the first user 102 (e.g. the first user's 102 toolkit) using the web server 271 (290). The first user 102 requests a seal of the registration document (291). The request is signed using the private key of the first user 102. The request includes, for example, a hash of the registration document and the one-time key. The manager 110 receives the seal request and validates the information. The manager 110 has the corresponding public key for the private key of the first user 102. For example, the validation process includes checking the signature and hash values against the hash value calculated by the manager 110 over the registration document data and the one-time key linked with the user ID in the database (e.g. archive 118). The verification process ensures the seal request came from the toolkit of the first user 102 and the first user 102 is associated with the registration document. The manager 110, after verifying the request, generates a seal of the registration document (292). The seal is transmitted to the first user 102 (293).

The first user 102 executes a generate sealed registration document process (294) with the evidence server 272 through the web server 271. The first user 102 transmits the sealed registration document to the web server 271. The web server 272 invokes the user register process of the evidence server 272. The user registration process at the evidence server 272 includes, for example, verifying the seal, verifying the registration document, completing the registration of the first user 102 in the database of the manager 110, and/or the like. The evidence server 272 transmits an update (295) to the first user 102 via the web server 271. The update changes the wallet of the first user 102 from a preliminary status to a confirmed status. For example, the user ID and user name associated with the private key stored in the wallet are finalized.

The first user 102 transmits a request for a second seal (296) to the evidence server 272. The second seal is a counterseal of the registration document sealed by the first user 102. The web server 271 transmits the sealed registration document to the evidence server 272. The evidence server 272 invokes a seal request of the evidence server 272 over the registration document. The manager 110 receives the seal request from the evidence server 272 and validates the evidence server 272 signed the request (e.g. using the public and private key pair of the evidence server 272). The manager 110 validates the request, for example, by checking the signature using the registered public key of the evidence server 272 contained in the database of the manager 110. The manager 110 creates a second seal of the registration document (297) for the registration authority 273 (e.g. the toolkit of the registration authority 273 is used to invoke the second sealing request). The manager 110 transmits the seal to the evidence server 272. The countersealed registration document is stored in the database of the manager 110 (298). The countersealed registration document can be transmitted to the user by email, using the email address stored in the database 110.

FIG. 4C is an example of a registration document 230 created through the registration process 270 of FIGS. 4A and 4B. The registration document includes the registration details of the toolkit (e.g. the toolkit 108). The registration details for the registering user include a User ID field 231A, a User Name field 232A, and an Email field 233A, which in this exemplary registration document 230 contain the values “98339844” 231B, “Test User” 232B, and “m.clarke@evident-technologies.com” 233B, consecutively. The registration details for the community include a Community ID field 234A and a Community Name field 235A, which contain the values “3” 234B and “Trial” 235B. The registration details for the registration authority include a RA User ID 236A and RA User Name 237A, which contain the values “56729126” 236B and “Mike Clarke” 237B, consecutively. Referencing FIG. 4A, the registration details are transmitted by the first user 102 to the web server 271 in the registration request step 286.

For the registration document 230, the user ID field 23 1A is unique within a community (e.g. defined by the community ID field 234A). The community ID field 234A is unique within a manager cluster, where a manager cluster is a group of one or more managers 110 assigned to one or more communities. A user (e.g. the first user 102) can use the same key but have different registration details for multiple roles in the sealing system. A community ID 234A can be, for example, associated with a company, where the community is the company. The user ID 231 A can be assigned to different employees with different roles within the community, such as the president, CEO, and/or the like. A user can get a license number from the registration authority for that community to facilitate registering a toolkit 108 within the community.

The registration document 230 comprises an additional information field 238 which can be used to further describe a user's context within a community. In this example, the additional information field 238 is a license agreement. The completed registration document 230 includes two seals, the client seal 239 and the registration authority seal 240. Referencing FIG. 4B, the client seal 239 is created in steps 290, 291, and 292. The registration authority seal 240 is created in steps 296 and 297. The client seal 239 and registration authority seal 240 can demonstrate the seal agreement between the first user 102 and the registration authority 273. The registration authority seal 240 can show there is a binding agreement with the first user 102 and the registration authority 273 regarding the use of the seals. For example, if a user (using a desktop file sealer 201A, 201B) seals a tax form on their behalf as an individual, the seal is claimed only as an individual. If a user seals a contractual agreement on behalf of a company, the user puts the company behind the seal so the company could be held responsible even though the user acted as an individual. Advantageously, seals can mimic any legal document since legal documents are signed within a context.

A registration document can be used to establish a trusted peer to peer relationship between a user (e.g. the first user 102) and one or more other parties (e.g. the second user 104 or any additional user). For example, a heart monitoring laboratory (e.g., laboratory A) can establish a trust relationship with a hospital (e.g., hospital A). The registration document of the heart monitoring laboratory can include an agreement (e.g. in the additional information field 238) detailing a contractual agreement of the heart monitoring laboratory to serve as a subcontractor with hospital A to provide heart monitoring tests for patients referred to the laboratory by the hospital under a $1M contract. The community for the heart monitoring laboratory is the hospital (e.g. stored in the Community ID field 234A and the Community Name field 235A), and the user is the heart monitoring laboratory (e.g. stored in the User ID field 231A, the User Name field 232A, and the Email field 233A). The registration document can allow the hospital to verify electronic data sealed by the heart monitoring laboratory in the context of the underlying contract between the two parties. For example, when laboratory A seals patient data and transmits that data to hospital A, hospital A can verify that the seal was in fact created by laboratory A under the context in which laboratory A registered with hospital A using the registration process described herein.

The heart monitoring laboratory can use multiple registration documents to establish peer to peer relationships with other hospitals. For example, heart monitoring laboratory can have a different registration document with hospital B detailing a contractual agreement to provide CT scans for patients to hospital B under a $10K contract. The hospital (the relying party) knows data from the heart monitoring laboratory can be trusted and was sealed within the context of the binding contract in the registration document. The registration document for hospital A and the registration document for hospital B can use the same key with different connotations because the individual registration document defines the context between the two parties involved. Advantageously, a relying party does not need to trust a third party (e.g. the manager 110) but can rely on the peer to peer relationship between the two parties. Trust is only placed in the cryptography used during the sealing process. If the cryptography of a key (e.g. in the toolkit 108) is compromised, the key can be immediately disabled in the manager 110 database for all the registration documents sealed using the key, and no further seals can be created using the compromised key. A new license key can be issued to replace the compromised key, creating new keys and registration documents using the new license key.

A service (e.g. the first user 102) can use the registration process 270 to register and seal for an individual application in the event a server supports multiple applications for multiple companies. For example, if a web service can support multiple applications, each application can be separately registered and seal documents on behalf of each corporation. An example of a Web service (e.g., a Web portal) supporting multiple companies supporting multiple applications is outlined in TABLE 8 below.

TABLE 8

| Company | Service |
|---|---|
| X | Air Ticket Receipts |
| X | E-Banking Services |
| X | Notarized Services |
| Y | Shipping Services |
| Y | E-Banking Services |

Referring to TABLE 8, column one indicates the company, which is either company “X” or company “Y.” Column two indicates the service the company is offering through the web service. Company X is offering “Air Ticket Receipts,” “E-Banking Services,” and “Notarized Services.” Company Y is offering “Shipping Services” and “E-Banking Services.” Company X has a registration document with the community of company X (e.g. stored in the Community ID field 234A and the Community Name field 235A). Each service offered can have an assigned user ID (e.g. the User ID 231A). For example, “Air Ticket Receipts” can have the user ID of “A,” “E-Banking Services” can have the user ID of “B,” and “Notarized Services” can have the user ID of “C.” When the web service issues an air travel receipt for the “Air Ticket Receipts” service for company X, the web service can seal the air travel receipt on behalf of the “Air Tickets Receipts” application for company X with the registration document containing the user ID of “A” and the community ID of “X.” Advantageously, the web server can have a list of multiple user ID's and community ID's (e.g. stored in the data store 206) to seal documents on behalf of different companies for various applications.

Each user ID and community ID pair has a registration document, and the registration documents can all be created using the same key. In some embodiments, a unique key can be used for each registration document. The registration document gives the context that a service has with a company (e.g. the context the “Air Ticket Receipts,” “E-Banking Services,” or “Notarized Services” service has with company “X”). As another example, an email system can have all the users of the system individually registered (e.g. with their own, unique registration document), and it can seal email messages on behalf of individual users. The registration documents can all be generated using the same key, so the email server can represent multiple users with the one key.

FIG. 5 is an exemplary diagram of a format of a seal 300. The encapsulated data 302 can include the electronic data the user (e.g. the first user of FIG. 1) submitted to be sealed (e.g. by the toolkit 108). In some embodiments, the encapsulated data 302 may be omitted or set to NULL. The encapsulated data 302 can be encoded and/or encapsulated electronic data. The electronic data can be a HTML document, a XML document, graphic data (e.g., a .jpeg file), a word processing document, a spreadsheet, a multimedia document, an audio document, a video document, and/or the like. The encapsulated data 302 can be, for example, Multipurpose Internet Mail Extensions (MIME) encapsulated multimedia data. The seal 300 includes seal data 304. In general, the seal data 304 includes information used to verify the data was not changed since the data was sealed, who requested the data to be sealed, the time the data was sealed, applicable evidence metadata, and/or the like.

The seal data 304 includes an ID field 306. The ID field 306 can be the ID of the user that requested the seal be created. When there are several registered identities (e.g. in the manager 110), the ID field 306 can include a user ID field, community ID field, and/or the like. For example, a community ID can be the name of a company, and the user ID field can be the name of an employee who has privileges to seal documents under the applicable community ID. The seal data section 304 includes a data hash value field 308 (e.g. the unique hash value generated by the toolkit 108 in FIG. 1). The seal data section 304 includes a time field 310 (e.g. the timestamp generated by the manager 110 in FIG. 2).

The seal data 304 also includes a reference data field 312. The reference data field 312 can be, for example, a text string of XML encoded evidence metadata which can be rendered as a simple text string. The reference data field 312 can be visible to users (e.g. the first user 102 of FIG. 1) as a text string, stored with other seal data by the manager 110 in the data store 206, and/or the like. The seal data 304 includes an external reference field 314. In general, the external reference field 314 can include zero to “n” external reference files. For each external reference file 316, the external reference field 314 contains a unique hash of the external file and a link to the external file. The external reference field 314 of FIG. 5 illustrates an example that includes external file one 316A, external file two 316B, and external file n 316N (generally referred to as external files 316) and/or references thereto. The external files 316 can be in any format. The external reference field 314 can comprise XML encoded information about the external files 316 (e.g. the hash of the external file 316 and link to the external file 316). The seal 300 can support a seal per electronic data, multiple electronic data files in one seal, and/or the like. The seal can be combined with external files 316 to make one file (e.g. using a utility such a zip, tar, gzip, etc.).

The seal 300 can be, for example, an HTML seal. For an HTML seal, the sealed data 302 can be an HTML file. For an HTML seal, the seal 300 can seal external files of any format. The HTML file (e.g. the seal 300) and any external documents can be zipped into one evidence file. The seal 300 can be provided in the form of an object which can be added into the HTML document at a user defined point (e.g. a specific tag). For example, the tag can have the form of “<!-beginevidencesealpanel_{—}001_{—}0005_{—}01C24DB4.99AF74E0--><--end evidencesealpanel_{—}001_{—}0005_{—}01C24DB4.99AF74E0-->”. This allows an HTML document to include the seal, which facilitates displaying the seal to a user using, for example, a web browser.

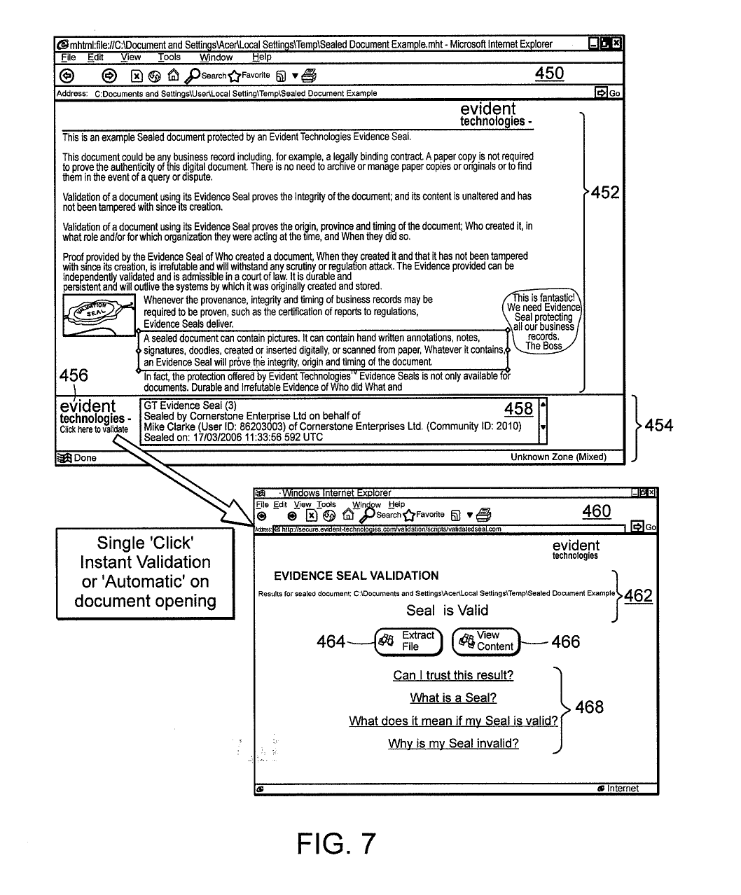

The HTML seal can be created using the EVIDENCE_CreateSeal function described in FIG. 3. The EVIDENCE_CreateSeal, for example, takes the electronic data file as input and produces a sealed output HTML file which can be viewed in a browser (e.g. the web browser 262 of FIG. 3). The appearance of the HTML file can be controlled with a template. Evidence metadata, which will be described in more detail with reference to FIG. 7, can be added to the reference data field 312. This can be included in the “pRefData” parameter described in TABLE 1. External files of any type may and/or references to such files be added to the seal. An external file, for example, can be hashed (e.g. by the toolkit 108 of FIG. 1), the hash value placed in the HTML seal along with the file name, path data, and other relevant information necessary to locate the external file from the seal. An HTML seal and any additional external files can be zipped into one file by setting the “pActionFlag” in TABLE 1 to 1.

A user can validate an HTML seal (e.g. the seal 300) by clicking on a seal icon (not shown) while using the web browser 262 (FIG. 3), using the EVIDENCE_ValidateSeal function of the API 258 (FIG. 3), and/or the like. A default template can be used to validate the seal. The template may be modified to customize the seal validation. For external files 316 in the external reference field 314, the validation process (e.g. the execution of the EVIDENCE_ValidateSeal function) can attempt to access the files, create a hash value for each external file, and validate the hash values in the seal 300. The validation process can attempt to access the files in the location specified in the seal 300 (e.g. information in the “ExternalPointer” parameter in TABLE 3), the same directory as the seal 300, and/or the like. The validation process can return an error code, for example in the “ErrorString” output of the EVIDENCE_ValidateSeal function, if the hash values do not match, external files can not be located, the user's sealed registration document can not be trusted, and other conditions indicating the seal is bad. Otherwise, the EVIDENCE_ValidateSeal method can return EVIDENCE_ERR_NOERROR to indicate a successful validation.

The seal 300 can be, for example, a MIME+HTML (MHT) seal. The MHT seal can encode the document (e.g. using RFC 2045 MIME) and the seal in a single file which can be viewed through a browser (e.g. IE, Firefox, etc.). Evidence metadata can be added to the MHT seal in the same way as HTML seals. Additional external files (e.g. not MIME enveloped in the contents) can be added to the MHT seal in the same way as HTML seals. The seal 300 can be a detached seal.

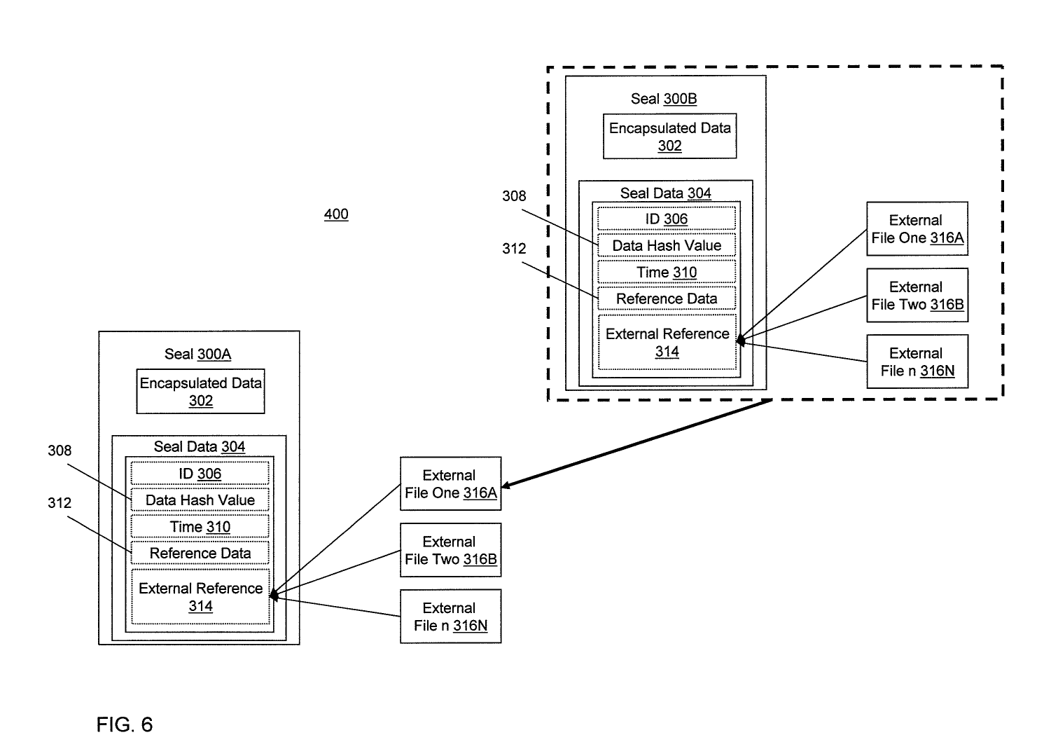

FIG. 6 is a diagram of a nested evidence file 400. The seal 300A includes the same components as the seal 300 in FIG. 5, which are the encapsulated data 302 and the seal data section 304, which includes the ID field 306, the data hash value 308, the time field 310, the reference data field 312, and an external reference field 314. The external reference field 314 includes zero or more external files (e.g. external file one 316A, external file two 316B, through external file n 316N, generally external files 316) and/or references thereto. The seal 300B can include the same components as the seal 300A.

The external files 316 included in the external reference field 314 of seal 300B can be of any type. A seal (e.g. seal 300B) can be nested within a separate seal (e.g. seal 300A). This can be done, for example, by adding seal 300B to seal 300A as an external file (e.g. external file one 316A). Nested seals can be used, for example, for an electronic notary system. For example, a consularized seal can include an apostilled seal as an external reference (e.g. external file 316 in the external reference field 314). The apostilled seal can include an external reference to a notarized/oath seal file. The notarized/oath seal file can include a reference to a certified seal, and the certified seal can include nested customer evidence files.

FIG. 7 is an exemplary screen shot of the seal display 450 using a computer file system exploring window. The seal being viewed can be, for example, an HTML seal. The seal can be viewed using the web browser 262 of FIG. 3, the desktop file sealer 201A, 201B of FIG. 2, and other viewing systems capable of reading the seal. The seal display 450 includes a document body 452 and a seal pane 454. The document body 452 is the electronic data sealed by the toolkit 180 (e.g. the electronic data submitted by a user, such as the first user 102 or second user 104 of FIG. 1). It is worth noting that the exemplary document body 452 of this example is a scan that includes some handwritten notes on a typed document. In this case, the seal is verifying that this scanned document, including the hand written notes, has not been altered since the document was sealed. The seal pane 454 includes a validation button 456 and a textual seal display 458. The validation button 456 can, for example, be clicked by a user to verify the seal of the document. The seal pane 458 can include a textual representation of seal data, such as the fields of the seal 300 of FIG. 5, such as the ID 306, the time 310, the reference data 312, the external files 316 pointed to by the external reference field 314, and other evidentiary metadata associated with the seal 300.

A validation pane 460 can be generated upon the occurrence of a certain event, such as when a user clicks the validation button 456, upon opening the sealed document, and/or the like. The validation pane 460 includes a validation result field 462. The validation result field 462 displays the result of the seal validation process (e.g. a call of the EVIDENCE_ValidateSeal function through the API 258 of FIG. 3). The validation result field 462 can indicate the seal is valid or the seal is invalid. If the seal is invalid, the validation result field 462 can indicate which sealing party to contact regarding further validation of the seal. For example, if the seal is determined to be invalid, the electronic data can still be validated by comparing the seal against the archived copy, for example archived in the data store 206 of FIG. 2. This will be explained in further detail in reference to FIG. 9.

The validation pane 460 includes an extract file button 464. The extract file button 464 can be used to extract external references (e.g. external files 316 included in the external reference field 314). Pressing the extract file button 464 can, for example, call the EVIDENCE_ExtractFileFromSeal method described in conjunction with FIG. 3 and display the returned information in a new window (not shown). The EVIDENCE_GetNumberOfSeals method can be invoked to return the number of seals associated with a sealed document. The EVIDENCE_GetNumberOfSeals can be used, for example, with nested seals such as external files 316 in the external reference field 314 which include seals.

The validation pane 460 also includes a view contents button 466. The view contents button 466 can be used to view the contents of seal data (e.g. the fields of the seal data section 304). Pressing the view contents button 466 can, for example, call the EVIDENCE_GetSeallnfo method described in conjunction with FIG. 3 and display the information in a new window (not shown). The validation pane 460 includes a user information link section 468. The user information link section 468 includes links (e.g. “Can I trust this result”, “What is a seal”, “What does it mean if my seal is valid?”, “Why is my Seal invalid,” and other useful links which users can click on to learn more about the sealing process and how to interpret the result of their validation request. For example, clicking on the “Can I trust this result?” link can take the user to a new window which has an explanation of how the seal was created and validated to give the user an understanding of why they can rely on the seal.

A user can validate an electronic data document 452 by clicking the validation button 456. If, for example, the seal (e.g. a seal 300) is of a multi-media document, clicking on the validation button 456 can initiate the use of a template (not shown) to control the validation process. The template, which can be provided with the toolkit 108, can point the user's seal display 450 to the appropriate validation service. The validation service can be the validation server 208 of FIG. 2, a third party site responsible for validating the seals, and/or the like. This can, for example, load up an Active X plug-in into the browser that validates the seal.

The EVIDENCE_ValidateSeal function can be used to check the validity of the seal to determine if the electronic data has been changed, verify the seal is valid, compare the document within the seal against the original document, and/or other like functions. The validation process can generate a hash of the sealed document and compare the generated hash value to the hash value stored in the seal. The hash value in the seal can be the data hash value 308. If there are hash values and references of additional external files 316 in the external reference field 314, the validation process can access the files, create a hash value for each external file 316, and verify the hash values. These files can be specified in the “ExernalPointer” parameter of the EVIDENCE_ValidateSeal method of the API 258. Failure to locate the external files 316 can cause the validation process to fail. Failure of the hash values to match, for either the sealed electronic document or the external files 316 can cause the verification process to fail. If the verification process fails, the validation result field 462 of the validation pane 460 will indicate the verification failure and provide instructions on how to contact the sealing party to further verify the seal. This can be done by accessing the archives, such as the archives stored by the manager 110 in the data store 206.

For example, the evidentiary metadata in the seal can indicate the document was sealed by a manager (e.g. the manager 110) operated by “ABC Enterprises Ltd”, the ID field 306 indicated the ID of the user which initiated the seal request had a user ID of “66203003” which maps to the user “John Smith” and a community ID number “2010” which maps to the community “ABC Enterprises Ltd.,” the time field 310 indicates the document was sealed on 12/03/2005 at 11:33:58.592 UTC. The textual seal display 458 can indicate this information in textual representation such as: “GT: Evidence Seal (3), Sealed by ABC Enterprises Ltd. on behalf of: John Smith (User ID: 66203003) of ABC Enterprises Ltd. (Community ID 2010), Sealed on 12/03/2005 at 11:33:58.592 UTC.”

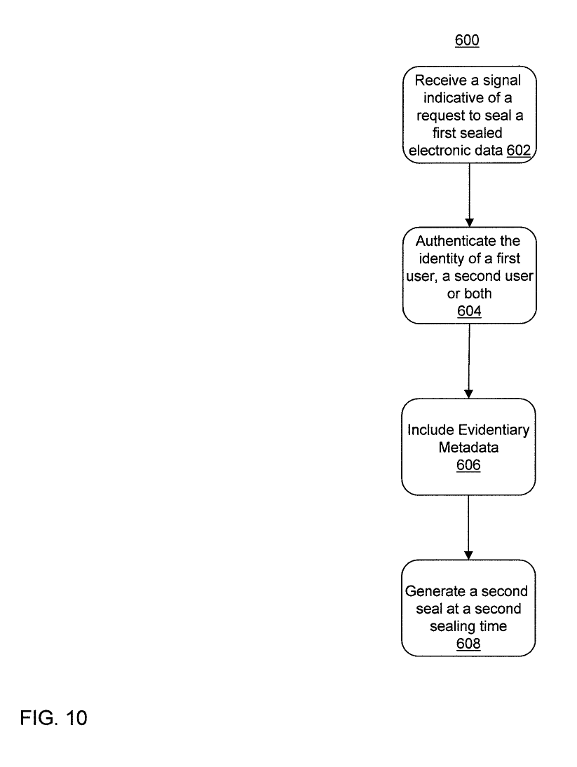

FIG. 8 is a screenshot of an exemplary user interface of the desktop file sealer 201 described in FIG. 2. The desktop file sealer 201 can reside, for example, on the local computer of a user (e.g. the first user 102 or second user 104 of FIG. 2). The desktop file sealer 201 includes an “Open” button 502. The open button 502 can be clicked by a user, which can invoke an open dialog (not shown) which can allow a user to browse for a file, select the file, and input the file into the desktop file sealer 201. The desktop file sealer 201 includes a “Seal” button 504 which can allow a user to invoke the sealing process for the included documents in the desktop file sealer 201. The extract button 506 allows the user to store the original data locally if the original data was encapsulated in an MHT file. The reference field 508 of the desktop file sealer 201 can allow a user to input reference metadata. This will be described in more detail in conjunction with FIG. 10. The desktop file sealer 201 includes a display pane 510. The display pane 510 graphically displays the paths to the files of the electronic data the user has loaded into the desktop file sealer 201 before pressing 504 the seal button. The desktop file sealer 201 includes a status window 512. The status window 512 can display to the user of the desktop file sealer 201 the progress of the sealing routine by referring to the paths of the set of files as each file is sealed.

A user can browse the local file system using a browsing window 520. The browsing window 520 can be independent of the desktop file sealer 201. The user can drag a document 522 from the browsing window 520 into the display pane 510 to load the document 522 into the desktop file sealer 201. The seal button 504 and the extract button 506 will remain inactive (e.g. the user can not click the button) until an electronic data file is loaded into the desktop file sealer 201.

A user can generate a seal in multiple ways using the desktop file sealer 201. A user can, for example, generate a seal by loading the electronic data by clicking on the open button 502, selecting a particular document, and loading the document into the desktop file sealer 201. A user can instead browse for an electronic document using the native file system utilities (e.g. a file system explorer), locate the document, and drag and drop the document into the display pane 510. A user can invoke the sealing process on a loaded document in the desktop file sealer 201 by clicking the seal button 504, which can become active once the document is loaded into the desktop file sealer 201. Pressing the seal button 504 sends a request to the toolkit 108 to seal the electronic data the user loaded into the desktop file sealer 201. The sealing process is described in detail with reference to FIG. 2. The status window can indicate the progress of the sealing process of each file. For example, when the user presses the seal button 504, a text string can display the path of the sealed file.

FIG. 9 is a flow chart of an exemplary archive sealing process 550, which will be described in reference to the sealing system 200 of FIG. 2. In step 552, a plurality of seals is generated using a first sealing algorithm. The plurality of seals can be created, for example, by the manager 110 through the toolkit 108. The plurality of seals can be created at different times. The plurality of seals is stored in an archive of seals (554). The storing (554) of the seals can occur at different times. The archive of seals can be included in the data store 206. In step 556, the archive of seals is sealed using a second sealing algorithm. This second sealing of the archive of seals ensures that the archive of seals is not changed or altered in any way, so that the seals in the archive can be relied upon at any time in the future. The archive of seals can be sealed each time a seal is created, daily, weekly, monthly, or at any other time chosen by a sealing party (e.g. the first user 102). The second sealing algorithm used to seal the archive of seals can be the same sealing algorithm as the first sealing algorithm, or the second sealing algorithm can be a different sealing algorithm. The sealing algorithms follow the same sealing process outlined in FIG. 2, but can use different asynchronous key encryption algorithms, different hashing functions, rely on different UTC time sources, and/or the like.

Because the second sealing algorithm is sealing the archives of seals already created, and thus can be different from the first sealing algorithm, the second sealing algorithm can be advantageously updated as newer algorithms (e.g., key, hashing, etc.) become available. The seal of the archive can be stored by a trusted party. The trusted party can be a reliable third party, the seal creating party, and/or the like. The seal of the archive can be digitally signed by the trusted party.

The manager 110 can ensure the archive of seals is not modified by sealing the archive of seals. The sealing algorithm can be improved when new technology is created, when a weakness of a sealing algorithm is discovered, or any other reason to update the sealing algorithm. Re-sealing the archive of seals ensures the latest sealing technology is used to protect the stored copies of seals generated by the manager 110. The manager 110 can use updated sealing algorithms as they are developed in place of the previous outdated sealing algorithms. The updated, or second sealing algorithm, can be implemented in a new version of the software, a patch to the software, or other software update method generally used in the industry. Re-sealing the archive of seals can allow a user to rely on the stored seal in the event a seal is jeopardized or a sealed registration document becomes invalid or retired.

The manager 110 can receive a plurality of seals generated using a first sealing algorithm (552) and store the plurality of seals in an archive of seals (554) (e.g. the data store 206). The manager 110 can, for example, add the plurality of seals to an existing archive of previously generated seals. The seal can be stored with relevant information (e.g., indexed via this information) to expedite finding the seal at a later point in time. Such relevant information can include seal creation time, user information, toolkit 108 information, and/or the like. The manager 110 can seal the archive of seals with the first sealing algorithm used to generate the plurality of seals. If, for example, a second sealing algorithm is developed as an improvement to a previous first sealing algorithm, subsequent sealing of the archives can use this improved sealing algorithm. Further, the archive can be re-sealed by a second set of seals using the improved sealing algorithm, without affecting the seals in the archive that may need to be relied upon in the future. This second set of seals can include one or more seals. The second set of seals can replace the previous set of seals sealing the archive or the second set of seals can simply seal over the previous set of seals sealing the archive, in this case creating a third layer of seals (e.g., the originally stored seals, the previous seal of the archives, and an improved seal of the original seals and of the previous seal of the archives). The manager can store the new second set of seals in the archive of seals (554). The archive of seals can be re-sealed using a new sealing algorithm each time a seal is created, weekly, monthly, when a sealed registration document is compromised, or at any other time chosen by a sealing party (e.g. the first user 102).

The sealed archive of seals (e.g. the data store 206) can be utilized to verify seals that are no longer verifiable. If, for example, a sealed registration document is retired, the seal can not be validated (e.g. by the validation server 208). The sealed archive of seals allows a seal associated with a revoked sealed registration document to be validated. The validation server 208 can query the data store 206 to acquire a valid copy of the seal and compare the existing seal with the archived seal to validate the data. The data store 206 can be located at any suitable storage facility, including a trusted third party to provide additional assurance and independent validation for sealed data. A sealed archive of seals does not risk compromising the confidentiality of the electronic data because only the one-way hashes of the data are maintained by the archive. For example, the toolkit 108 only transmits the generated hash of the electronic data to the manager 110.

FIG. 10 is a flow chart of an exemplary process 600 for generating multiple seals of a document. In step 602 a signal indicative of a request to seal a first sealed electronic data is received (e.g. by the toolkit 108). In some examples, the first sealed electronic data can be generated by a first user, and the signal indicative of a request to seal the first sealed electronic data can be requested by a second user. The first sealed electronic data can be generated by a manager, such as the manager 110, at a first sealing time. The identity of the first user and/or the second use can be authenticated (604). The manager 110 can perform the authentication. In step 606, evidentiary metadata can be included in the seal. Evidentiary metadata can be any data used for verification of the electronic document or used to evidence additional information that is to be maintained as part of the seal. For example, in the case of a notary sealing a document, the notary might add a description of the identification used to identify the user associated with the sealed electronic data. The evidentiary metadata can be added by the manager 110, added by the second user generating the second seal of the first electronic data, or added during another step when pertinent information regarding the seal creation can be added. A second seal can be generated at a second sealing time of the first sealed electronic data (608). The second seal can be generated by the manager 110, stored in the data store 206, and/or the like.

The evidentiary metadata included (606) in the seal can be a wide variety of evidentiary metadata and the following describe some of the exemplary types of evidentiary metadata that can be included. Evidentiary metadata can be related to the organization which created the seals, such as authenticated information about the user (e.g. the first user 102, second user 104, seal requesting party, or any other user), the toolkit 108, the manager 110, the party responsible for the data store 206, and any other party which plays a role in the seal generation. The evidentiary metadata can be related to the transaction, such as the document type, a party's role in the transaction, the intended recipient of the document, and/or the like. The metadata can include data that might be needed if the evidence is to be submitted in a court of law. Evidentiary metadata can encapsulate human observations and actions, such as the presentation of the data, clarification of an indication of intent, motivating decisions of a user, and other human observations and actions. Evidentiary metadata can be unrelated to the electronic data. Evidentiary metadata can be used to validate the identity of the parties (e.g. the first user and the second user), the state of the original electronic data, the time of an event or a sequence of events, provide a context for the meaning of the seal, and other evidence metadata.

Evidentiary metadata can be user defined. Evidentiary metadata can be an external file included within the external reference field, such as the external reference field 314 of the seal 300 in FIG. 5. The external file can have a user generated style sheet indicative of formulating the display of the external file into a human-readable format. For example, the evidentiary metadata can be encapsulated in an external XML text string file, and a style sheet can be included as a second external file which is added to the seal allowing the XML file to be viewed by a user. The evidentiary metadata can be included in the reference data field, such as the reference data field 312 of the seal 300. The external file can be, for example, a previously generated seal. The seal, which can be generated by the toolkit 108 and the manager 110, can demonstrate all the sealed evidence metadata was authentic at the time the seal was created. The evidentiary metadata can include the electronic data identified by the signed hash, a trusted time mark, and application specific data that is needed for long term evidence purposes.

Evidentiary metadata can include, for example, a photocopy of a passport, audio data, video data, graphics, a social security number, a license number, a passport, a birth certificate, a credit card number, a bank account number, an email address, a contract offer, a contract acceptance, a transfer of goods record, a contract amendment, a medical document, the message header of an email, data associated with a word processing document, and any other relevant data associated with the underlying electronic data.

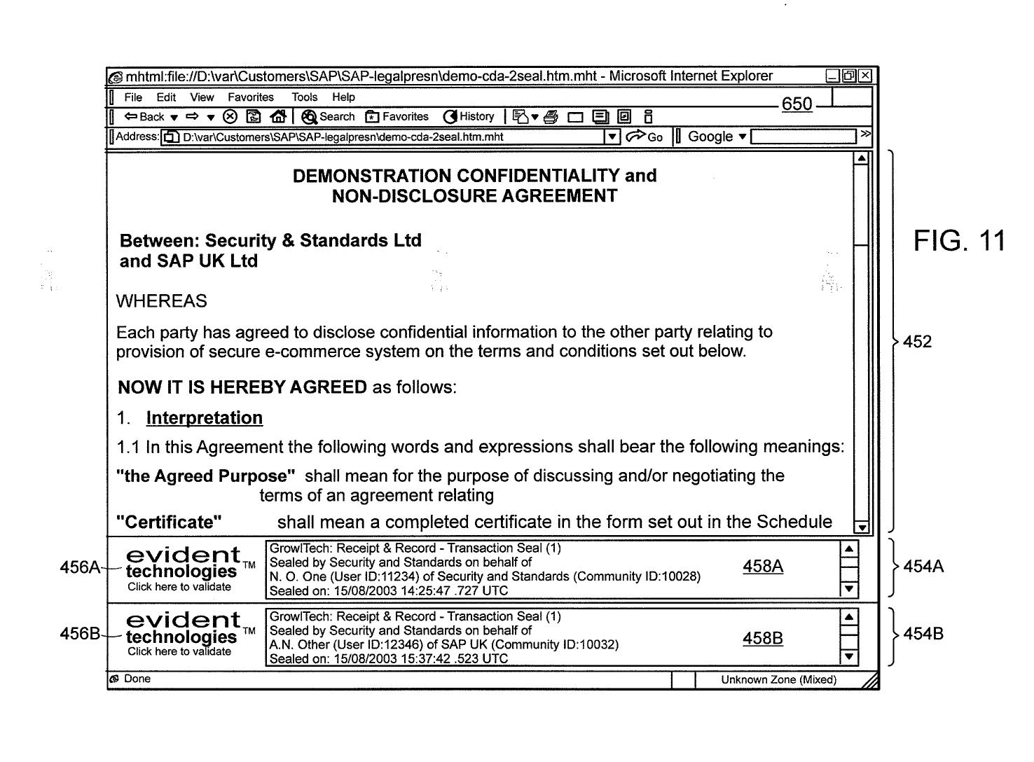

FIG. 11 is an exemplary multiple seal display 650, which includes similar components of the seal display 450 of FIG. 7. The seal can be viewed using the web browser 262 of FIG. 3, the desktop file sealer 201A, 201B of FIG. 2, and other viewing systems capable of reading the encoded seal data. The multiple seal display 650 includes a document body 452. The multiple seal display 650 includes a seal pane for each seal of the document 454A, 454B, generally referred to as seal pane 454. Each seal pane 454 has a corresponding validation button 456A, 456B, generally referred to as validation button 456. Each validation button 456 can, for example, be clicked by a user to verify the corresponding seal of the document. The seal pane 458 can include a textual representation of seal data such as the ID 306, time 310, reference data 312, external files 316 pointed to by the external reference field 314, and other evidentiary metadata associated with the seal 300.

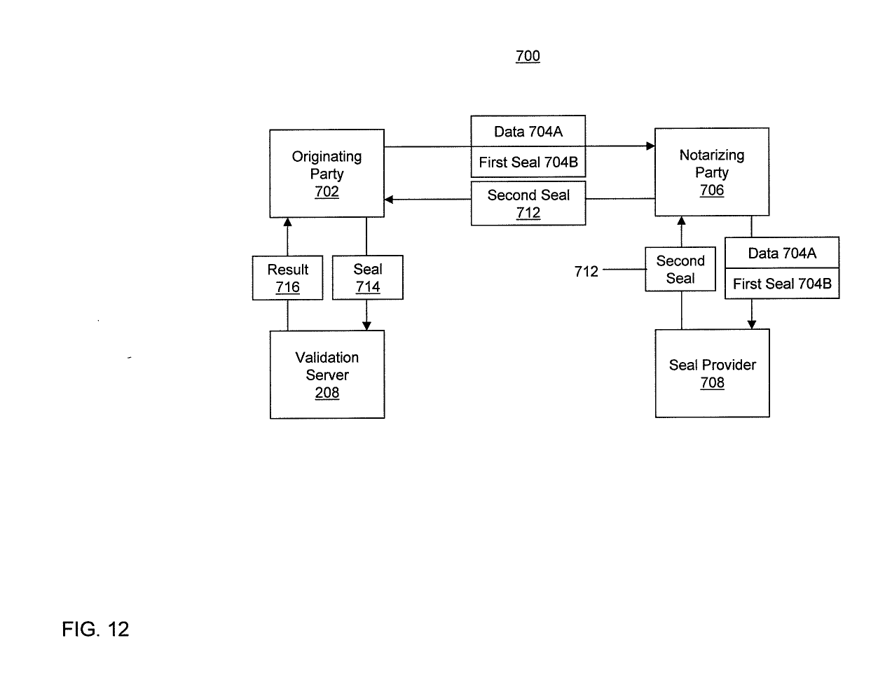

For example, the seal corresponding to seal pane 454A can be validated independently of the seal corresponding to seal pane 454B by clicking on the validation button 456A. The validation process is described in detail with reference to FIG. 7. Multiple seals are desirable, for example, for an electronic notary service. A creating party, e.g. first user 102, can seal an electronic data and transmit the sealed electronic data to a second party, e.g. the notarizing party. The notarizing party can compress (e.g. using zip) the electronic data together with any external files linked to the seal, generate a hash of the compressed document, and include the hash as an external file of the notarizing party. The notarizing process is described in more detail with reference to FIG. 12.

FIG. 12 is a block diagram of a notarizing service 700. The originating party 702 represents the party which created the electronic data. The originating party 702 can represent, for example, a user requesting a notarizing service and/or the communication device(s) used by such party. The originating party 702 can transmit data 704A (e.g. the electronic data that was sealed) and a first seal 704B (e.g. the seal of the electronic data) to a notarizing party 706. The data 704A and first seal 704B can be referred to, collectively, as a set of sealed data 704. The notarizing party 706 can represent, for example, a user performing a notarizing service, the notarizing service itself, and/or the communication device(s) used for the notarizing service. The notarizing party 706 is in communication with the seal provider 708. The seal provider can be the manager 110 of FIG. 1. The notarizing party 706 can make a seal request from the seal provider 708 by sending the set of sealed data 704 (e.g. the data 704A and the first seal 704B) to the seal provider 708. The seal provider 708 can generate a second seal 712 of that set of sealed data 704. The seal provider 708 can transmit the second seal 712 to the notarizing party 706. The notarizing party 706 can transmit the second seal 712 to the originating party 702. The originating party 702 is in communication with a validation server 208. The originating party 708 can transmit a seal 714 to the validation server 208 to verify the seal. The seal 714 can be the first seal 704B, second seal 712, or any other seal. The validation server 208 can verify the seal (e.g. through the process described in reference to FIG. 7). The validation server 208 can return the result 716 of the validation to the originating party 708. The result 716 can be valid, invalid, uncertain, needs further evidence to validate, and/or the like.

The seal provider 708 (e.g. a manager 110 of FIG. 1, 2) creates a seal using the secret key of the seal provider 708 in the hardware of the seal provider 708. The seal provider 708 uses a self-signed certificate to verify the seal provider 708 while the certificate is valid. The validation server 208 uses the certificate of the seal provider 708 to verify the seal provider 708. The validation server 208 can maintain a list of seal providers for use when verifying a seal. If the certificate becomes invalid, the user is pointed to the seal provider 708, who can use the archived copy of the seal (e.g. in the data store 206 of FIG. 2) to validate the seal. If the certificate is valid, the validation server then computes a hash of the document and compares the hash with the hash contained in the seal.

The originating party 702 can interface with the notarizing party 706 to facilitate authentication so the notarizing party 706 verifies the identity of the originating party 702 (e.g. as a trusted user of the notarizing service 700). The originating party 702 can be verified using, for example, asymmetric encryption with a public and private key set. The notarizing party 706 can be running, for example, through a web portal.

In some examples, the electronic data that is sealed can be a contract that is embodied as an electronic document. The originating party 702 can create the electronic contract and sign the contract electronically and then generate a first seal of the signed contract to ensure that its contents are not modified after the electronic signing. The first seal can be generated, for example, by using a toolkit 108 associated with the originating party 702 through the process described with reference to sealing system 200 of FIG. 2. The originating party can transmit the contract and the first seal to the notarizing party 706. The originating party 702 can identify the application service (e.g. web portal) and itself as a user. The notarizing party 706 can authenticate the application service and itself as a notary. The notarizing party 706 can notarize the first sealed data (in this example, the electronic contract and its seal generated by the originating party 702). The notarizing party 706 can notarize this first sealed data, for example, by generating a second seal of the first sealed data. The notarizing party 706 can include as evidentiary metadata in the second seal the source of the toolkit 108 used by the originating party 702, the source of the toolkit 108 used by the sealing party 706, the registration information of the originating party 702, the validation of the identity of the sealing party 706, the source of the electronic data, and other evidentiary information which can be useful to validate the notarized data.

The first seal 704B and second seal 712 can be separate seals and can be stored separately in an archive of seals (e.g. the data store 206). The second seal can be applied over the data included in the sealed data 704A, over the sealed data 704A, or any other combination. The originating party 702 can view the first seal 704B, the second seal 712, or both seals. The originating party 702 can validate the first seal 704B, the second seal 712, or both seals using the validation server 208. When the second seal 712 is created by, for example, the sealing party 708, evidentiary metadata associated with the first seal can be associated as evidentiary metadata of the second seal.

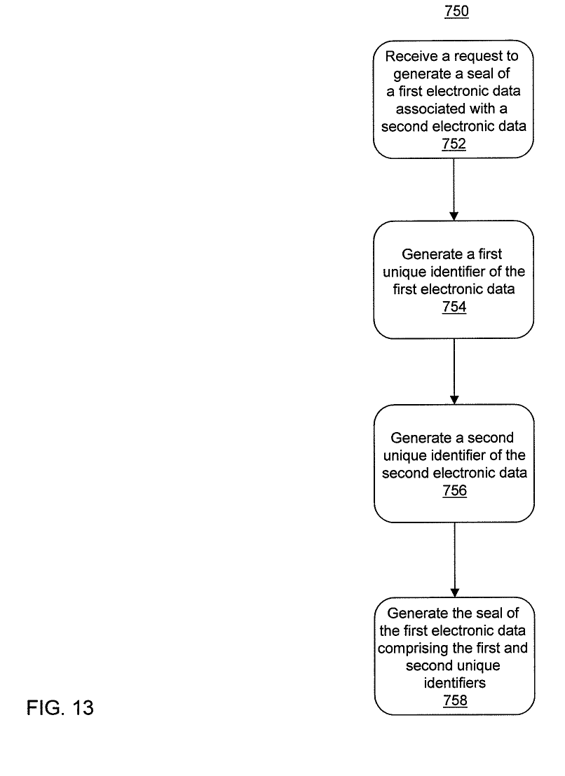

FIG. 13 is a flow chart of an exemplary multiple document sealing process 750, which can use some of the components of the sealing system 200 of FIG. 2. In step 752, a request is received to generate a seal of a first electronic data associated with a second electronic data (e.g., a .jpeg image file included in a slide presentation). The request can be received by the toolkit 108. A first unique identifier is generated of the first electronic data (754). The unique identifier can be, for example, a hash value of the electronic data. The unique identifier can be generated by the toolkit 108. In step 756, a second unique identifier (e.g. a hash value) of the second electronic data can be generated. Step 758 generates the seal of the first electronic data which comprises the first and second unique identifiers of the first electronic data and second electronic data. Referencing the seal 300 of FIG. 5, the first unique identifier can be stored in the data hash value 308. The second unique identifier can be stored in the external reference field 314. There can be, for example, multiple second electronic data resulting in multiple unique identifiers in the external reference field 314.

The multiple document sealing process 750 can be used, for example, to seal an email including one or more attachment files. The requesting party (e.g. the first user 102, second user 104, or any additional user) can transmit an email including attachments. The toolkit 108 receives a request to generate a seal of a first electronic data (e.g. the email) associated with a second electronic data (e.g. the attachment files) (752). The toolkit 108 receives the email with attachments, and generates a first unique identifier, a hash, of the first electronic data (e.g. the email text body) (754). The toolkit 108 can include the email header as evidentiary metadata (e.g. in the reference data field 312, in the external reference field 314 as an external file 316A, and/or the like). For each attachment file, the toolkit 108 generates a corresponding hash value. The toolkit 108 can generate an additional hash value of the combination of the hash values for the email attachments to generate a second unique identifier of the second electronic data (e.g. the attachment files) (756). In some embodiments, the email attachments can be compressed (e.g. zipped) together and one hash of the compressed file can be generated by the toolkit 108.

The toolkit 108 can sign the hash data using the private key of the toolkit 108. The toolkit 108 can transmit the signed hash values to the manager 110. This eliminates, for example, transmitting the entire document to the manager 110, helping to preserve the secrecy of the document. The manager 110 can validate the user's identity and sealed registration document using the public key of the toolkit 108 located, for example, in the wallet 205 of the manager 110. The manager 110 can include the hash value for each email attachment file and a link to the external attachment file in the seal. The manager 110 can stop the sealing process if the sealed registration document is invalid. By stopping the sealing process for an invalid sealed registration document, the manager 110 can ensure a seal is created only by a validated user. This can ensure the archive of seals only includes valid seals. If the sealed registration document is valid, the manager 110 can continue with the sealing process to generate a seal. For example, the hash value and a link to the external file 316A can be included in the external reference field 314 of seal 300 in FIG. 5. The hash of each email can be saved as evidentiary metadata. The manager 110 generates a seal of the first electronic data (e.g. the email) comprising the first and second unique identifiers (e.g. the hash of the email body and the hash value of the attachment files) (758). The seal may include the additional information discussed with reference to the sealing system 200 of FIG. 2.

A receiving party can validate the seal of the email and attachment documents to verify the email text and attachments were not altered inadvertently or purposely by a third party. For example, the validating party (e.g. the first user 102 or second user 104) transmits the sealed email with attachments to a validator (e.g. the validation server 208 of FIG. 12). The validator can use a public key (e.g. contained in a sealed registration document of a manager 110) to verify the associated manager 110 is valid. If the seal can not be trusted, a message can be transmitted to the validating party indicative of the validator being unable to verify the seal. The message can instruct the validating party to contact the seal creating party for further validation. If the sealed registration document is retired, the electronic data can still be validated by going to the sealed archive of seals (e.g. the data store 206 described in conjunction with FIG. 9) and comparing the seal with the original seal stored in the sealed archive of seals.

If the seal can be trusted, the validator can verify the seal data. The validator can calculate a new hash value of the email body and compare the calculated hash value with the hash value of the email body contained in the seal. If the two hash values do not match, the validator can stop the validation process and notify the validating party the email has changed. If the two hash values match, the validator can additionally verify the attachments associated with the email have not changed. For each attachment (e.g. external file 316 linked by the external reference field 314), the validator can locate the attachment (e.g. using the link in the external reference field) and calculate a new hash value of the attachment. The validator can compare the calculated hash value with the hash value in the seal corresponding to that specific attachment (e.g. the hash associated with the link for the external file 316 in the external reference field) to validate each attachment. If the two hash values are different, the validator can terminate the validation process and notify the validating party the applicable attachment has been modified. If all the attachment hash values are unchanged, the valdiator can notify the validating party the email and the attachments have not been altered. In some embodiments, the email, all of its attachments, and the original file are all packaged together, uncompressed or compressed (e.g., in a zip file), so that locating the file requires nothing more than retrieving that file (e.g., an attachment) from the group of packaged files.

To enhance the applicability of the electronic data seals, the sealing process can comply with electronic signature legislations, such as the UK Electronic Communications Act 2000, the European Directive 199/93/EC on a Community Framework for Electronic Signatures, the US Electronic Signatures in Global and National Commerce (ESIGN) Act 2000, and other electronic signature legislations. Applications can be developed to add the sealing functionality to existing applications, such as text editors, voice records, video records, and web site content.

The above-described systems and methods can be implemented in digital electronic circuitry, in computer hardware, firmware, and/or software. The implementation can be as a computer program product (i.e., a computer program tangibly embodied in an information carrier). The implementation can, for example, be in a machine-readable storage device and/or in a propagated signal, for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by and an apparatus can be implemented as special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can include and can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device. The display device can, for example, be a cathode ray tube (CRT) and/or a liquid crystal display (LCD) monitor. The interaction with a user can, for example, be a display of information to the user and a keyboard and a pointing device (e.g., a mouse or a trackball) by which the user can provide input to the computer (e.g., interact with a user interface element). Other kinds of devices can be used to provide for interaction with a user. Other devices can, for example, be feedback provided to the user in any form of sensory feedback (e.g., visual feedback, auditory feedback, or tactile feedback). Input from the user can, for example, be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks. Communications networks can include packet-based networks and circuit-based networks. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, bluetooth, code-division multiple access (CDMA) network, time division multiple access (TDMA) network, global system for mobile communications (GSM) network), and/or other circuit-based networks.

The system can include clients and servers. A client and a server are generally remote from each other and typically interact through a communication network. The relationship of client and server arises by virtue of computer programs running on the respective computers and having a client-server relationship to each other.

The communication device can include, for example, a computer, a computer with a browser device, a telephone, an IP phone, a mobile device (e.g., cellular phone, personal digital assistant (PDA) device, laptop computer, electronic mail device), and/or other communication devices. The browser device includes, for example, a computer (e.g., desktop computer, laptop computer) with a world wide web browser (e.g., Microsoft® Internet Explorer® available from Microsoft Corporation, Mozilla® Firefox available from Mozilla Corporation). The mobile computing device includes, for example, a Blackberry®. The IP phone includes, for example, a Cisco® Unified IP Phone 7985G available from Cisco System, Inc, and/or a Cisco® Unified Wireless Phone 7920 available from Cisco System, Inc.

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A method comprising:
receiving a request associated with a user to generate a seal of a first electronic data, the first electronic data being associated with a second electronic data;
generating a first unique identifier of the first electronic data;
generating a second unique identifier of the second electronic data; and
generating the seal of the first electronic data comprising the first unique identifier and second unique identifier.

2. The method of claim 1, wherein the first electronic data comprises an email and the second electronic data comprises an attachment of the email.

3. The method of claim 1, wherein the second electronic data comprises an external file.

4. The method of claim 1, wherein the seal comprises:
an authentication information of the user;
the first unique identifier;
a sealing time; and
an external reference associated with the second electronic data.

5. The method of claim 4, wherein the seal comprises a reference data.

6. The method of claim 5, wherein the reference data comprises a text string.

7. The method of claim 4, wherein the external reference comprises the second unique identifier and an external reference to the second electronic data.

8. The method of claim 4, wherein the seal comprises a plurality of external references.

9. The method of claim 4, wherein the external reference is associated with evidentiary data.

10. The method of claim 9, wherein the evidentiary data comprises a multimedia data.

11. The method of claim 10, wherein multimedia data includes audio data, video data, graphics, or any combination thereof.

12. The method of claim 4, wherein the sealing time is a trusted time.

13. The method of claim 1, wherein the second electronic data comprises a second seal.

14. The method of claim 13, wherein the second seal comprises external references.

15. The method of claim 1, further comprising:
receiving a request associated with a second user indicative of validating the first electronic data;
verifying the first unique identifier is identical to the first electronic data; and
verifying the second unique identifier is identical to the second electronic data.

16. The method of claim 1, wherein the first electronic data comprises a sealed document, a personal information, a legal transaction, a medical document, a multimedia data, or any combination thereof.

17. The method of claim 1, further comprising storing the seal separately from the first electronic data.

18. The method of claim 1, further comprising storing the seal and the first electronic data in an electronic file.

19. The method of claim 1, further comprising using an API to execute a command.

20. The method of claim 19, wherein the command is operative of creating the seal of the first electronic data, validating the seal of the first electronic data, or extracting information from the seal of the first electronic data.

21. A system comprising one or more computing devices configured to:
receive a request associated with a user to generate a seal of a first electronic data, the first electronic data being associated with a second electronic data;
generate a first unique identifier of the first electronic data;
generate a second unique identifier of the second electronic data; and
generate the seal of the first electronic data comprising the first unique identifier and second unique identifier.

22. The system of claim 21, further comprising a validation server configured to:
receive a request associated with the first user or any additional user indicative of validating the first electronic data;
verify the first unique identifier belongs to a first data which is identical to the first electronic data; and
verify the second unique identifier belongs to a second data which is identical to the second electronic data.

23. The system of claim 21, wherein the one or more computing devices configured to generate the seal are local to the user.

24. The system of claim 21, wherein a manager does not receive the first electronic data or second electronic data.

25. The system of claim 21, further comprising a computer display configured to:
display the sealed first electronic data in a first area of the computer display; and
display the seal in one or more other areas of the computer display.

26. A computer program product, tangibly embodied in an information carrier, the computer program product including instructions being operable to cause a data processing apparatus to:
receive a request associated with a user to generate a seal of a first electronic data, the first electronic data being associated with a second electronic data;
generate a first unique identifier of the first electronic data;
generate a second unique identifier of the second electronic data; and
generate the seal of the first electronic data comprising the first unique identifier and second unique identifier.

27. A system comprising:
a means for receiving a request associated with a user to generate a seal of a first electronic data, the first electronic data being associated with a second electronic data;
a means for generating a first unique identifier of the first electronic data;
a means for generating a second unique identifier of the second electronic data; and
a means for generating the seal of the first electronic data comprising the first unique identifier and second unique identifier.
